(19) United States
(12) Patent Application Publication
(10) Pub. No.: US 2026/0059565 A1
(43) Pub. Date: Feb. 26, 2026

(54) INTER-BASE-STATION CROSS-LINK INTERFERENCE MANAGEMENT WITH DYNAMIC TIME DIVISION DUPLEXING

(71) Applicant: Lenovo (Singapore) Pte. Limited, Singapore (SG)

(72) Inventors: Majid Ghanbarinejad, Chicago, IL (US); Hyejung Jung, Northbrook, IL (US); Vijay Nangia, Woodridge, IL (US); Hossein Bagheri, Dearborn Heights, MI (US)

(21) Appl. No.: 19/102,619

(22) PCT Filed: Aug. 7, 2023
(86) PCT No.: PCT/IB2023/057964

§ 371 Date: Feb. 10, 2025

Related U.S. Application Data
(60) Provisional application No. 63/371,066, filed on Aug. 10, 2022.

(51) Int. Cl. H04W 72/541; H04L 5/14; H04W 72/1273

(52) U.S. Cl. CPC H04W 72/541; H04L 5/14; H04W 72/1273

(57) ABSTRACT

Various aspects of the present disclosure relate to a base station and methods that manage cross-link interference during wireless communication especially in dynamic time division duplexing (TDD) using flexible symbols. In one aspect, a processor of an originating base station is configured to cause the base station to: determine downlink transmission parameters to communicate downlink resources to the one or more user equipment (UEs); and identify a spatial pattern to communicate the downlink resources to the one or more UEs. The processor is further configured to cause the base station to communicate, to a second base station, a spatial pattern information element (IE) containing at least one indication of the spatial pattern for cross-link interference management, the spatial pattern IE enabling the second base station to mitigate interference.

### PRIORITY APPLICATION

This application claims priority to U.S. Provisional Application No. 63/371,066 filed Aug. 10, 2022, the content of which is fully incorporated herein.

### TECHNICAL FIELD

The present disclosure relates to wireless communications, and more specifically to wireless communications that support dynamic time division duplexing (TDD).

### BACKGROUND

A wireless communications system may include one or multiple network communication devices, including base stations, which may be otherwise known as an eNodeB (eNB), a next-generation NodeB (gNB), or other suitable terminology. Each network communication device, such as a base station, may support wireless communications for one or multiple user communication devices, which may be otherwise known as user equipment (UE), or other suitable terminology. The wireless communications system may support wireless communications with one or multiple user communication devices by utilizing resources of the wireless communications system (e.g., time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, and other suitable radio access technologies beyond 5G (e.g., sixth generation (6G)).

Time division duplexing (TDD) of uplink and downlink signals enables base stations such as gNBs to utilize available spectral resources defined in time and frequency domains to provide communication services to a population of UEs within a coverage area of the respective base station. Recent enhancements to radio access technologies (RATs) include high radio frequencies that can be spatially directed in narrow beams, achieving increased antenna gains and providing opportunities to reduce interference to UEs that are at a different direction from the base station. In addition, rather than being confined to static TDD with rigidly defined allocations of the available time resource to uplink and the downlink, the base stations are increasingly able to support dynamic TDD communication, adapting scheduling to communication demands.

### SUMMARY

The present disclosure relates to methods, apparatuses, and systems that provide wireless communication that reduce inter-cellular (cross-link) interference, especially in dynamically changing configuration and association of uplink and downlink resources. An aggressor base station and a victim base station in a wireless communications system communicate and coordinate on beam pattern information and the beams that cause excessive interference. The aggressor base station informs the victim base station of an intention to apply certain beams for communication. In response, the victim base station measures interference of each beam and informs the aggressor base station which beams cause excessive interference. The base stations may then communicate further to compromise on beam patterns being used in order to mitigate cross-link interference.

Some implementations of the methods and apparatuses described herein may include supporting wireless communication by a network node that is an aggressor base node. The methods include determining downlink transmission parameters to communicate downlink resources to one or more user devices. The method includes identifying a spatial pattern to communicate the downlink resources to the one or more user devices. The method includes communicating, via a network interface of the network node to a second network node, a beam pattern information element (IE) containing at least one indication of the spatial pattern for cross-link interference management. The spatial pattern IE enables the second network node to measure and mitigate interference by the spatial pattern on communications, according to a second spatial pattern in some implementations, being generated by the second network node.

Some implementations of the methods and apparatuses described herein may support wireless communication by a network device that is a victim network node. The method includes receiving, via a network interface of the network node from an originating network node, a spatial pattern IE comprising one or more beam pattern entries, each containing at least one indication of a spatial pattern transmitted by the originating network node. The method includes obtaining an interference estimate based on measurements on a resource set associated with a reference signal identified by the spatial pattern IE. The method includes comparing the interference estimate with an interference threshold. In response to determining that the interference estimate is larger than the interference threshold, the method includes communicating a high-interference beam indication to the originating network node to prompt a cross-link interference mitigation action by the originating network node.

### BRIEF DESCRIPTION OF THE DRAWINGS

FIG. 1 illustrates an example of a wireless communications system enabling wireless communication that supports cross-link interference management between network nodes, in accordance with aspects of the present disclosure.

FIGS. 2, 3A-3B, 4A-4B, and 5-17 present different example code blocks that implement different embodiments for cross-link interference management between network nodes, in accordance with aspects of the present disclosure.

FIG. 18 illustrates an example scenario of a communication environment for inter-cell OTA indication of slot format, in accordance with aspects of the present disclosure.

FIG. 19 is a timing diagram that presents a method that is employed by the various entities in the example scenario, in accordance with aspects of the present disclosure.

FIGS. 20-26 present different example code blocks that implement different embodiments for cross-link interference management between network nodes, in accordance with aspects of the present disclosure.

FIG. 27 illustrates an example of a block diagram of a user device that wirelessly communicates with the network nodes that schedules dynamically changing flexible symbols in response to changes in communication traffic, in accordance with aspects of the present disclosure.

FIG. 28 illustrates an example of a block diagram of a network device that wirelessly communicates with user devices, and which also communicates with other network nodes for cross-link interference management as an aggressor and/or a victim network node, in accordance with aspects of the present disclosure.

FIG. 29 illustrates a flowchart of a method performed by a network device, as an aggressor network node, that performs cross-link interference management, in accordance with aspects of the present disclosure.

FIG. 30 illustrates a flowchart of a method performed by a network device operating as a victim network node for cross-link interference management, in accordance with aspects of the present disclosure.

### DETAILED DESCRIPTION

In wireless communications systems, time division duplexing (TDD) refers to the scheme of splitting radio resources among downlinks and uplinks in the time domain. At any point in time in a given frequency, either the base station transmits downlink signals to one or more subscriber user devices, or the user devices transmit uplink signals to the base station. Normally, during TDD transmissions, uplink signals are not transmitted at the same time as downlink signals in the same frequency. In conventional cellular systems employing static TDD, patterns of TDD are fully synchronized and typically identical to avoid interference from a downlink transmitted by one base station transmitting to another base station of a nearby cell that is receiving an uplink. When dynamic TDD is employed, different TDD patterns may be used that are not synchronized with neighboring cells. Interference from one base station to another may dynamically occur as each base station dynamically changes respective uplink (UL) and downlink (DL) beam patterns, degrading performance.

Furthermore, with beamforming at millimeter-wave frequencies, interference caused by a base station on another base station may be significant depending on the beamforming configurations at the aggressor base station and the victim base station. For example, if an aggressor base station happens to transmit a downlink signal with a transmit (Tx) beam that is spatially directed toward the victim base station, and the victim base station happens to receive an uplink signal on the same time-frequency resources with a receive (Rx) beam spatially directed toward the aggressor base station, the downlink signal may cause an excessive interference on the uplink signal. This interference may be avoided by proper signaling and coordination among base stations.

The present disclosure provides systems and methods for inter-base-station cross-link interference (CLI) management, such as between NR gNBs. In particular, the present disclosure addresses the following situations and elements: (i) a source or aggressor gNB indicating Tx beam information to a target or victim gNB; (ii) the aggressor gNB indicating time and frequency information associated with Tx beams to the victim gNB; (iii) a victim gNB indicating, to an aggressor gNB, information or an indication of beams that cause a large interference; (iv) the victim gNB indicating, to the aggressor gNB, information of time and frequency resources associated with beams that cause a large interference; (v) gNBs communicating transmit/receive (Tx/Rx) beam patterns; (vi) a victim gNB requesting an aggressor gNB to change beam pattern parameters, from among periodicity, beam, time and frequency; and (vii) an aggressor gNB/UE transmitting a reference signal as an over-the-air (OTA) indication of: (a) using a flexible resource for a communication, (b) a DL/UL direction of the communication, and/or (c) spatial and power information.

The aggressor base station gNB1 and the victim base station gNB2 communicate and coordinate on beam pattern information and on beams that cause excessive interference. gNB1 informs gNB2 of its intention to apply certain beams for DL communication. Then gNB2 measures interference of each beam and informs gNB1 which beams cause excessive interference. The two gNBs may then communicate further to reach a middle ground.

In a first embodiment, an aggressor base station sends to a victim base station a message or information element (IE) comprising a beam pattern, wherein the beam pattern indication comprises information of which beams are to be used on what time-frequency resources. The victim base station measures the interference on reference signals (e.g., SSB or CSI-RS) associated with each beam pattern entry to obtain an estimate of the upcoming interference. In a related second embodiment, the victim base station may report to the aggressor base station that certain beams or beam pattern entries cause excessive interference. In a third embodiment, the two base stations may exchange signaling to reconfigure the beam pattern such that scheduling constraints are met.

In an example of a method according to the first embodiment for interference management at a first (aggressor) base station, the method includes sending, to a second base station, a beam pattern message comprising one or more beam pattern entries. Each beam pattern entry includes an indication of at least one of: (i) a reference signal; (ii) one or more beams; (iii) a plurality of resources in at least one of a time domain and a frequency domain; and (iv) a transmission power parameter. The method includes determining whether to use a flexible symbol in the plurality of resources for a downlink communication while applying a beam from the one or more beams. Upon determining to use the flexible symbol, the method includes transmitting the reference signal.

In one or more embodiments, the reference signal includes at least one of a synchronization signal block (SSB) or a channel state information reference signal (CSI-RS). In one or more embodiments, the one or more beams indices include reference signal resource indices or reference signal (RS) identifiers (IDs). In one or more embodiments, the transmission power parameter is a transmission power offset with respect to a reference signal. In one or more embodiments, a downlink communication is scheduled on a physical downlink shared channel (PDSCH) by a downlink control information (DCI) message or a semi-persistent scheduling (SPS) configuration. In one or more embodiments, an uplink communication is scheduled on a physical uplink shared channel (PUSCH) by a downlink control information (DCI) message or a configured grant (CG).

In an example of a method according to the second embodiment for interference management at a second (victim) base station, the method includes receiving, from a first base station, a beam pattern message comprising one or more beam pattern entries. Each beam pattern entry includes an indication of at least one of: (i) a reference signal; (ii) one or more beams; (iii) a plurality of resources in at least one of a time domain and a frequency domain; and (iv) a transmission power parameter. The method includes performing a measurement on a resource set associated with the reference signal, indication of which comprised by one of the one or more beam pattern entries. The method includes obtaining an interference estimate based on the measurement. The method includes comparing the interference estimate with an interference threshold. Upon determining that the interference estimate is larger than the interference threshold, the method includes sending a high-interference beam indication comprising at least one of: (i) an index associated with the beam pattern entry; (ii) an index associated with the reference signal; (iii) an index associated with the one or more beams; and (iv) an amount of excess interference computed based on the interference estimate and the interference threshold.

In one or more embodiments, the reference signal includes at least one of a synchronization signal block (SSB) or a channel state information reference signal (CSI-RS). In one or more embodiments, the one or more beams indices comprise reference signal resource indices or reference signal (RS) identifiers (IDs). In one or more embodiments, the transmission power parameter is a transmission power offset with respect to a reference signal.

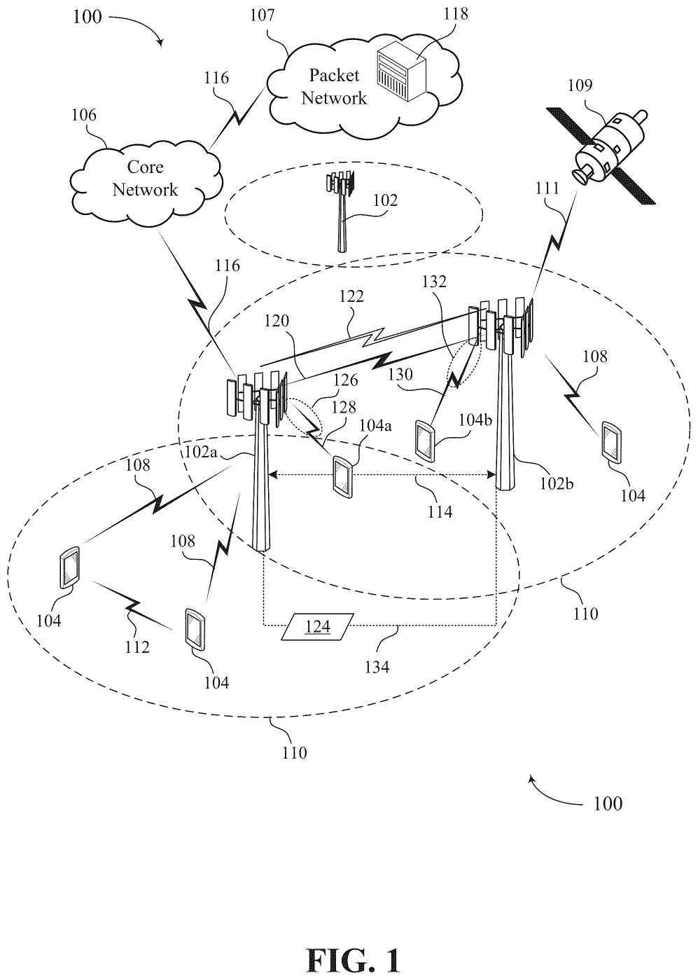

FIG. 1 illustrates an example of a wireless communications system 100 enabling wireless communication that supports cross-link interference management for wireless communication by network nodes, in accordance with aspects of the present disclosure. The wireless communications system 100 may include one or more network nodes 102, one or more UEs 104, a core network 106, and a packet data network 107. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as a New Radio (NR) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more network nodes 102 may be dispersed throughout a geographic region to form the wireless communications system 100. One or more of the network nodes 102 described herein may be, may include, or may be referred to as a base station, a base transceiver station, a network element, a radio access network (RAN), an access point, a NodeB, an eNodeB (eNB), a next-generation NodeB (gNB), a network entity, a network device, or other suitable terminology. A network node 102 and a UE 104 may communicate via a communication link 108, which may be a wireless or wired connection. For example, a network node 102 and a UE 104 may wirelessly communicate (e.g., receive signaling, transmit signaling) over a user to user (Uu) interface.

A network node 102 may provide a geographic coverage area 110 for which the network node 102 may support services (e.g., voice, video, packet data, messaging, broadcast, etc.) for one or more UEs 104 within the geographic coverage area 110. For example, a network node 102 and a UE 104 may support wireless communication of signals related to services (e.g., voice, video, packet data, messaging, broadcast, etc.) according to one or more radio access technologies. In some implementations, a network node 102 may be moveable, for example, a satellite 109 associated with a non-terrestrial network that communicates with the wireless communications system 100 via a satellite link 111. In some implementations, different geographic coverage areas 110 associated with the same or different radio access technologies may overlap, but the different geographic coverage areas 110 may be associated with different network nodes 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a remote unit, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the network nodes 102, other UEs 104, or network equipment (e.g., the core network 106, the packet data network 107, a relay device, an integrated access and backhaul (IAB) node, or another network equipment), as shown in FIG. 1. Additionally, or alternatively, a UE 104 may support communication with other network nodes 102 or UEs 104, which may act as relays in the wireless communications system 100.

In the description that follows, the timing of transmissions and retransmissions of control channels and data channels supports latency and/or error rate requirements for portions of video frames and may be referred to as time units. Time units, such as a symbol, slot, subslot, and transmission time interval (TTI), can have a particular duration. In an example, a symbol could be a fraction or percentage of an orthogonal frequency division multiplexing (OFDM) symbol length associated with a particular subcarrier spacing (SCS). In another example, an uplink (UL) transmission burst can be comprised of multiple transmissions. The multiple transmission can have the same priority, different priorities, or may have no associated priority. The multiple transmissions may include gaps between the transmissions that are short enough in duration to not necessitate performing a channel sensing or listen before transmit (LBT) operation between the transmissions.

A UE 104 may also be able to support wireless communication directly with other UEs 104 over a communication link 112. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 112 may be referred to as a sidelink. For example, a UE 104 may support wireless communication directly with another UE 104 over a PC5 interface. PC5 refers to a reference point where the UE 104 directly communicates with another UE 104 over a direct channel without requiring communication with the network node 102.

A network node 102 may support communications with the core network 106, or with another network node 102, or both. For example, a network node 102 may interface with the core network 106 through one or more backhaul links 114 (e.g., via an S1, N2, or another network interface). The network nodes 102 may communicate with each other over the backhaul links 114 (e.g., via an X2, Xn, or another network interface). In some implementations, the network nodes 102 may communicate with each other directly (e.g., between the network nodes 102). In some other implementations, the network nodes 102 may communicate with each other indirectly (e.g., via the core network 106). In some implementations, one or more network nodes 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

In some implementations, a network node 102 may be configured in a disaggregated architecture, which may be configured to utilize a protocol stack physically or logically distributed among two or more network nodes 102, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network node 102 may include one or more of a central unit (CU), a distributed unit (DU), a radio unit (RU), a RAN Intelligent Controller (RIC) (e.g., a Near-Real Time RIC (Near-RT RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission reception point (TRP). One or more components of the network nodes 102 in a disaggregated RAN architecture may be co-located, or one or more components of the network nodes 102 may be located in distributed locations (e.g., separate physical locations). In some implementations, one or more network nodes 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., Radio Resource Control (RRC), service data adaptation protocol (SDAP), Packet Data Convergence Protocol (PDCP)). The CU may be connected to one or more DUs or RUs, and the one or more DUs or RUs may host lower protocol layers, such as a layer 1 (L1) (e.g., physical (PHY) layer) or an L2 (e.g., radio link control (RLC) layer, medium access control (MAC) layer) functionality and signaling and may each be at least partially controlled by the CU.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network nodes 102 that are in communication via such communication links.

A network node 102 may act a particular time as an aggressor network node 102a, transmitting a downlink that causes cross-link interference 120 to a victim network node 102b when receiving an uplink. Each network node 102 may act sequentially or concurrently as both aggressor and victim to neighboring network nodes 102. An aggressor network node 102a and a victim network node 102b in a wireless communications system communicate and coordinate on beam pattern information and the beams that cause excessive interference via a backhaul or over-the-air (OTA) indication 122. The aggressor network node 102 informs the victim network node 102 of an intention to apply certain beams for downlink (DL) communication. In response, the victim network node measures interference of each beam and informs the aggressor network node 102b which beams cause excessive interference. The network nodes 102 may then communicate further to compromise on beam patterns being used for cross-link interference management.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more network nodes 102 associated with the core network 106. In one or more embodiments, the core network 106, such as at the AMF, may facilitate or manage the cross-link interference notifications and responses between aggressor network nodes 102a and victim network nodes 102b.

The core network 106 may communicate with the packet data network 107 over one or more backhaul links 116 (e.g., via an S1, N2, N2, or another network interface). The packet data network 107 may include an application server 118. In some implementations, one or more UEs 104 may communicate with the application server 118. A UE 104 may establish a session (e.g., a protocol data unit (PDU) session, or the like) with the core network 106 via a network node 102. The core network 106 may route traffic (e.g., control information, data, and the like) between the UE 104 and the application server 118 using the established session (e.g., the established PDU session). The PDU session may be an example of a logical connection between the UE 104 and the core network 106 (e.g., one or more network functions of the core network 106).

In the wireless communications system 100, the network nodes 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the network nodes 102 and the UEs 104 may support different resource structures. For example, the network nodes 102 and the UEs 104 may support different frame structures. In some implementations, such as in 4G, the network nodes 102 and the UEs 104 may support a single frame structure. In some other implementations, such as in 5G and among other suitable radio access technologies, the network nodes 102 and the UEs 104 may support various frame structures (i.e., multiple frame structures). The network nodes 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHZ), FR3 (7.125 GHz-24.25 GHz), FR4 (52.6 GHz-114.25 GHZ), FR4a or FR4-1 (52.6 GHz-71 GHz), and FR5 (114.25 GHz-300 GHz). In some implementations, the network nodes 102 and the UEs 104 may perform wireless communications over one or more of the operating frequency bands. In some implementations, FR1 may be used by the network nodes 102 and the UEs 104, among other equipment or devices for cellular communications traffic (e.g., control information, data). In some implementations, FR2 may be used by the network nodes 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

In a first embodiment according to aspects of the present disclosure, first network node 102a (e.g., gNB1) may send a message 124 to a second network node 102b (e.g., gNB2), where the message 124 includes an indication of a beam pattern. Network node 102a uses gNB1 Tx beam 126 to transmit a DL 128 to first UE 104a. Concurrently, second network node 102b receives an UL 130 from second UE 104b on a gNB2 Rx Beam 132. The Tx beam 126 and Rx beam 132 are oriented sufficiently toward one another that a significant amount of cross-link interference 120 is received by the second network node 102b. gNB1 may be the aggressor and gNB2 may be the victim in an inter-gNB interference scenario. The message may be transmitted over an Xn interface 134, in which case the beam pattern may conform to an Xn application protocol (XnAP) information element (IE). In one embodiment, the beam pattern is indicated in the time domain. An example is provided in TABLE 1:

TABLE 1

| | |
|---|---|
| Time interval #1 | Beam #1 |
| Time interval #2 | Beam #2 |
| Time interval #3 | Beam #3 |
| . . . | . . . |

Each time interval may be indicated in a unit of slots, symbols, frames, subframes, milliseconds, or the like. Each beam may be indicated by a parameter that indicates an association with a reference signal, such as a synchronization signal and physical broadcast channel (SS/PBCH) block (SSB), a channel state information reference signal (CSI-RS), or the like. An example of the parameter is a quasi-collocation (QCL) relationship, with the reference signal indicated as the source, e.g., a QCL Type D, or a transmission configuration indication (TCI) comprising information of the QCL relationship. Alternatively, each beam may be indicated by a direction, e.g., an angle with reference to a geographical direction or an angle with respect to a beam direction of a reference signal.

Since reference signal resources and QCL relationships are defined at radio resource control (RRC) layer, the XnAP IE may comprise the following information. In one embodiment, information of the reference signal resources, QCL relationships, and the like may be configured by the RRC layer at gNB1 and then passed up to the NG RAN layer in an RRC IE. Then, gNB1 (aggressor gNB) encapsulates the RRC IE in an XnAP IE and sends the XnAP IE to gNB2 (victim gNB) on an Xn interface. The NG RAN layer at gNB2 then decapsulates the message and passes the RRC IE down to the RRC layer, where the received information may be used for interference management.

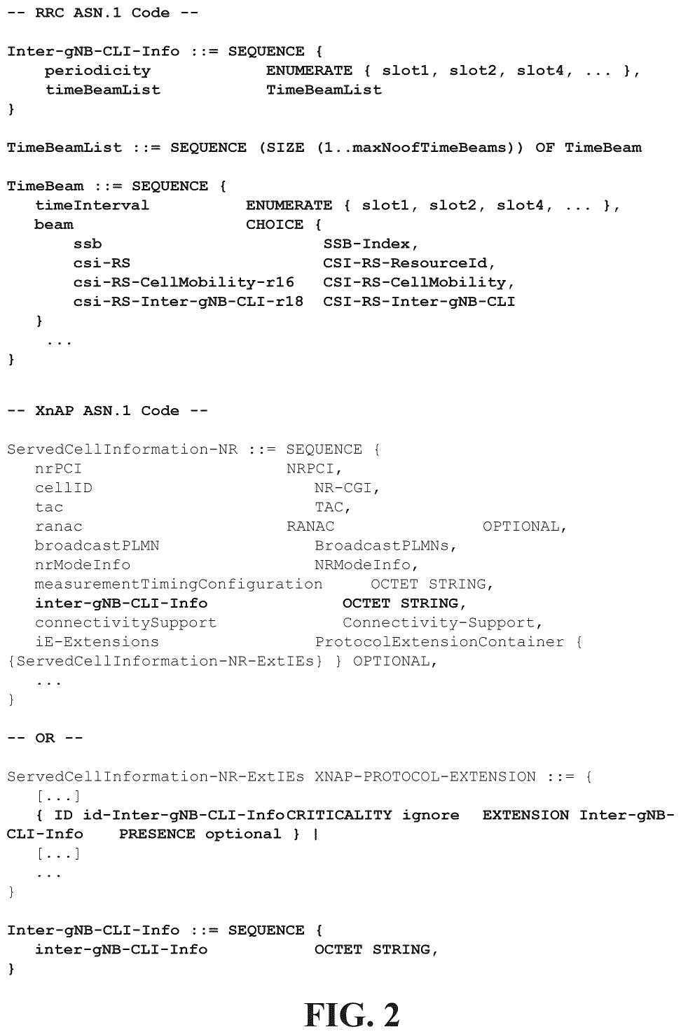

FIG. 2 is an example ASN.1 code for this realization. Bracketed ellipsis [ . . . ] denotes possibly omitted code. Bold font code shows the code introduced by the described implementation. In this example, the TimeBeamList IE is configured by the RRC in gNB1 and passed to the NG layer as a string of octets. The octet string is then transmitted on an Xn interface to gNB2 where the octet string is passed back to the RRC layer and decoded. In response to receiving the message/IE, gNB2 may take interference mitigation actions such as scheduling, link adaptation, etc., while taking the information in the message/IE into account.

Additionally, or alternatively, gNB2 may perform interference measurements and report high interference beams to gNB1 as proposed in Embodiment 2. In a more preferred realization, information of reference signal such as reference signal resources are passed from gNB1 to gNB2 in an RRC IE encapsulated in an XnAP IE. In this case, reference to reference signal indices defined in the RRC IE may be made in the XnAP IE.

In this example, the TimeBeamList IE is configured by the NG layer in gNB1 based on reference signal configured by the RRC. The IE is then transmitted on an Xn interface to gNB2 where it is decoded and used by gNB2 for interference mitigation. In response to receiving the message/IE, gNB2 may take interference mitigation actions such as scheduling, link adaptation, etc. while taking the information in the message/IE into account.

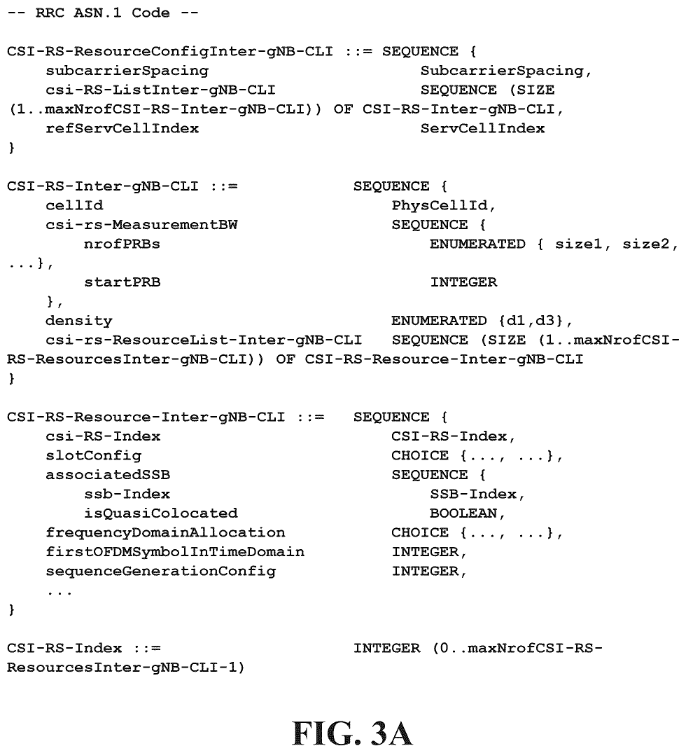

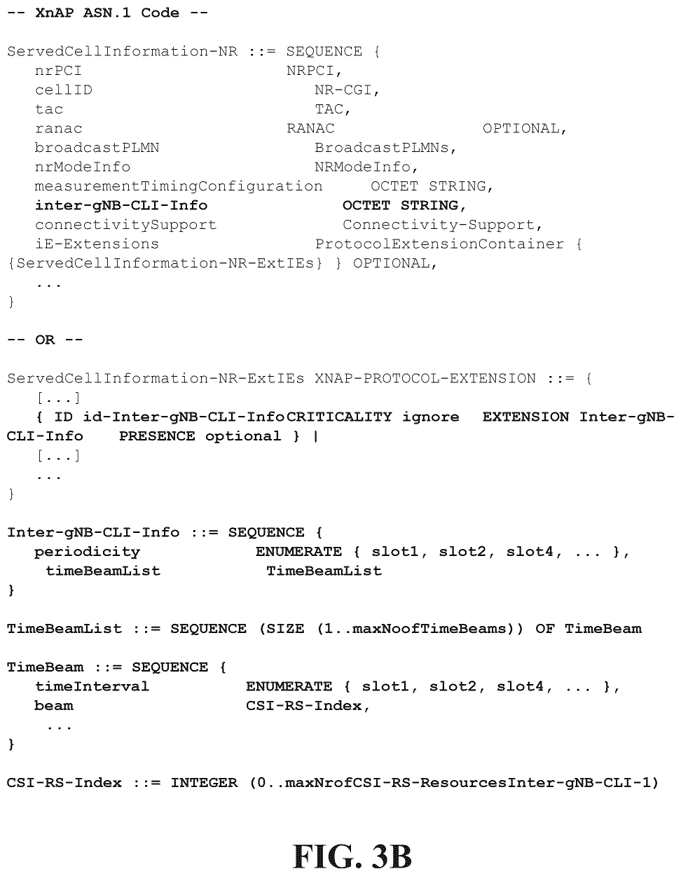

Additionally, or alternatively, gNB2 may perform interference measurements and report high interference beams to gNB1 as a proposed second embodiment. FIGS. 3A-3B (collectively “FIG. 3”) is an example ASN.1 code for this realization of the second embodiment. In this example, the TimeBeamList IE is configured by the NG layer in gNB1 based on reference signal configured by the RRC. The IE is then transmitted on an Xn interface to gNB2 where the IE is decoded and used by gNB2 for interference mitigation. In response to receiving the message/IE, gNB2 may take interference mitigation actions such as scheduling, link adaptation, etc. while taking the information in the message/IE into account. Additionally, or alternatively, gNB2 may perform interference measurements and report high interference beams to gNB1 as proposed in this second embodiment.

The above embodiments are essentially different in respect to which layer configures which parameters. In the first embodiment, both the reference signal configuration and the beam pattern are indicated by the RRC, while the XnAP IE encapsulates the RRC IE as a string of bits or octets. In the second embodiment, the reference signals are configured by the RRC, while the XnAP configures the beam pattern.

However, it is expected that the two embodiments result in a relatively similar implementation, as both configurations are expected to be performed in a central unit (CU) of the source network node gNB1. Similarly, the RRC and XnAP configurations are normally processed at a CU of the destination/target network node gNB2, hence resulting in relatively similar implementation.

Therefore, several embodiments of the present disclosure are described without necessarily specifying whether certain parameters are configured in an RRC IE, an XnAP IE, a combination thereof, or the like. For each embodiment, it should be appreciated that parameters conveying the information may be configured at one or more entities/layers.

In yet another embodiment, each entry in a beam pattern (for a serving cell) may comprise one or more of the following:
A: one or more beam indices, for example:
   A1: one or more reference signal indices,
   A2: one or more QCL relationships,
   A3: one or more TCI states;
B: one or more resources in the time domain, e.g., one or more slots, symbols, frames, subframes, etc., for example:
   B1: an indication of a subcarrier spacing associated with the duration of a slots or symbol,
   B2: a time pattern (e.g., a periodic time pattern, possibly along a valid duration for the periodic time pattern, or a bit map valid for a certain duration);
C: one or more resources in the frequency domain, e.g., one or more PRBs, RBGs, BWPs, etc., for example:
   C1: an indication of a subcarrier spacing associated with the bandwidth of a PRB, RBS, etc.;
D: one or more indications of a transmission power, for example:
   D1: one or more transmission power values with reference to a baseline, e.g., an SSB index, a CSI-RS index, etc.,
   D2: one or more offset values with respect to the baseline, for example in dB,
   D3: one or more indications of whether a transmission power is higher or lower than one or more thresholds.
      Additional details explaining the different ones of above beam patterns are as follows.

A: one or more beam indices: Each entry in the in the beam pattern indication may comprise one or more beam indices. This is particularly useful in frequency range 2 (FR2) or millimeter wave (mmWave) bands where the network node may apply beamforming, particularly analog beamforming, in order to transmit signals to UEs that are spatially separated. Coarse beams may be associated with SSBs while fine beams may be associated with other downlink reference signals such as CSI-RS.

The CSI-RS may be configured for inter-cell mobility and reused for the purpose of inter-gNB CLI management according to the second embodiment, or the CSI-RS may be configured specifically for inter-gNB CLI management.

In the former case, the message/IE from gNB1 to gNB2 may make a reference to a CSI-RS (or a CSI-RS resource) by including an index to the CSI-RS. Then, gNB2 interprets the reference signal index by considering an associated message/IE comprising information of CSI-RS configuration for mobility from gNB1. The associated message/IE may comprise a CSI-RS-ResourceConfigMobility IE, a CSI-RS-CellMobility IE, or the like.

In the latter case, gNB1 further sends a message/IE to gNB2, wherein the message comprises configuration of CSI-RS for inter-gNB CLI management. The configuration may be comprised in an RRC IE encapsulated in an XnAP IE as an octet string. Then, gNB2 interprets the reference signal index with reference to the CSI-RS configuration for inter-gNB CLI management.

A combination of the above is not precluded, i.e., the beam index may be interpreted with reference to a CSI-RS configured for inter-cell mobility or a CSI-RS configured for inter-gNB CLI management. In this case, the message/IE from gNB1 to gNB2 may comprise an additional indication of whether the referenced CSI-RS index is associated with CSI-RS for mobility or associated with CSI-RS for inter-gNB CLI management. Furthermore, in some embodiments, a CSI-RS index and an associated SSB index may be present in an entry.

If multiple beam indices are indicated in an entry of the beam pattern message, gNB2 may assume the worst-case interference. That is, gNB2 may assume that any of the beams associated with the indicated beam indices may be applied by gNB1 in the associated time/frequency resources (if indicated). In an example, a reference set of beams are indicated, and each gNB determines a set of beams based on the reference beams. For example, a set of coarse beams that can cover one or more narrower beams are indicated.

Each entry in the beam pattern indication message may comprise one or more (i.e., multiple) resource(s) in the time domain. For example, an entry may comprise an indication of a time interval indicated by starting and ending points in time in each periodicity, a number of slots, symbols, subframes, or frames in each periodicity, and so on. For example, in a periodicity of 20 slots, one or more entries may indicate beam patterns for slots 0, . . . , 9 and 10, . . . , 19 separately. Through this indication, gNB1 indicates to gNB2 that beams applied by gNB1 in downlink transmissions to UEs in the first 10 slots in every period/periodicity of 20 slots is expected/guaranteed to be different from the second 10 slots in that period/periodicity. A value of periodicity may be indicated by the beam pattern message, pre-configured by the OAM, specified by the standard, or a combination thereof. The value of periodicity may be negotiated between gNB1 and gNB2 as explained in the third embodiment introduced below.

If time/duration values are described in units of slots or symbols, an indication of an associated numerology, such as a subcarrier spacing indication, may be included in the message/IE from gNB1 to gNB2 or otherwise indicated to gNB2.

In some embodiments, a first gNB (e.g., victim gNB) indicates to a second gNB a time stamp of interference higher than a threshold or higher than expected, and then the second gNB (e.g., aggressor gNB) may determine the beam that was used by the second gNB in association with the time stamp. Then, in response, the second gNB may select a beam that is significantly different than the determined beam for future scheduling. In some realizations, the first gNB may only report the time stamp when the first gNB plans to schedule a transmission in a future time, which could be potentially severely impacted if the second gNB uses a similar beam as used at the moment of the time stamp. In some realizations, the first gNB only reports such a time stamp or in general reports interference issue to the second gNB for semi-statically scheduled transmissions.

Each entry in the beam pattern indication message may comprise one or more resource in the frequency domain. For example, in addition to association with a carrier frequency, component carrier (CC), bandwidth part (BWP), and/or the like, an entry may comprise an indication of one or more sub-bands indicated by starting and ending PRBs, RBGs, or the like, in the frequency domain. For example, in a bandwidth of 100 PRBs, one or more entries may indicate beam patterns for PRBs 0, . . . , 49 and 50, . . . , 99 separately. Through this indication, gNB1 indicates to gNB2 that beams applied by gNB1 in downlink transmissions to UEs in the first 50 PRBs of the 100-PRB bandwidth is expected/guaranteed to be different from the second 50 PRBs in that bandwidth. In one example, a resource indication value (RIV) may be used to indicate PRBs.

If time/duration values are described in units of slots or symbols, an indication of an associated numerology, such as a subcarrier spacing indication, may be included in the message/IE from gNB1 to gNB2 or otherwise indicated to gNB2.

Each entry in the beam pattern indication may comprise one or more parameters that indicate a transmission power applied to downlink transmissions by gNB1. When a higher transmission power is indicated, gNB2 may generally assume a larger interference as a result of the associated downlink transmissions.

Several realizations of transmission (Tx) power indication are possible. In one embodiment, a Tx power indication may comprise an offset, e.g., in dB, with respect to a reference signal. The reference signal may be indicated explicitly or implicitly. In an example explicit indication, the reference signal may be indicated in the Tx power indication parameter by an SSB index and/or a CSI-RS index. In an example implicit indication, a same reference signal associated with the beam index (parameter A described earlier) of a beam pattern entry may be taken as the reference signal for the Tx power indication of the said beam pattern entry.

In another embodiment, a Tx power indication may comprise an indication of whether a Tx power associated with the beam, time resource, and/or frequency resource (parameters A, B, C) is above a threshold. The threshold may be indicated by a signaling/configuration, an OAM pre-configuration, the standard specification, or a combination thereof. In this case, a one-bit or Boolean parameter may be sufficient to convey the information. For example, a value of ‘1’ may indicate that the Tx power is expected to exceed the threshold, or otherwise gNB1 may not guarantee the Tx power not exceeding the threshold; while a value of ‘O’ may indicate that the Tx power is expected or guaranteed to not exceed the threshold.

In yet another embodiment, two thresholds Th1 and Th2 may be considered for a Tx power indication. For example, assuming Th1<Th2, a value of ‘0’ may indicate that the Tx power is expected/guaranteed to not exceed Th1; a value of ‘1’ may indicate that the Tx power is expected/guaranteed to not exceed Th2; while a value of ‘2’ may indicate that gNB2 may not expect gNB1 to guarantee that the Tx power is below either of the thresholds.

By extension, more than two thresholds may be considered for a Tx power indication. In yet another embodiment, a Tx power indication parameter may indicate whether a Tx power associated with the indicated beam(s), time resource(s), and/or frequency resource(s) is guaranteed to be below any of multiple thresholds Th1, Th2, . . . , ThN. The thresholds may be signaled, (pre-) configured, specified, etc.

Embodiment 2: Indicating high-interference beams: a victim network node gNB2 may send a message to an aggressor network node gNB1, where the message includes an indication of high-interference beams. In order to indicate a beam, the message may include a reference signal index associated with the beam, which may be a reference signal index indicated in a message received earlier from gNB1.

In one embodiment, the message, received earlier from gNB1, may comprise information of SSB and/or CSI-RS configurations. The CSI-RS may be configured for inter-cell mobility, inter-gNB CLI management, and so on. In another embodiment, the message may alternatively, or additionally, comprise a beam pattern according to Embodiment 1.

The message from gNB2 to gNB1 may comprise the following information: (i) a parameter associated with a first message from gNB1 to gNB2, e.g., with a beam pattern indication IE according to the first embodiment; and (ii) one or more beam indices, wherein each of the one or more beam indices may be associated with a reference signal index indicated in an earlier message from gNB1 to gNB2, e.g., a reference signal index in a beam pattern indication IE according to the first embodiment. Furthermore, each one or more entries may be associated with a plurality of resources in time and/or frequency domains.

In one embodiment, gNB2 may indicate to gNB1 that an interference associated with a plurality of time and/or frequency resources is excessive. gNB2 may further indicate a value of excessive interference, e.g., in units of dB, by which gNB2 wishes the interference would be lower than measured. In this case, the message may be interpreted as a request from gNB2 to gNB1 to reduce the associated transmission power by the said indicated value, e.g., X dB. In response, gNB1 may reduce the associated transmission power by X dB, or another value in subsequent transmissions. Furthermore, gNB1 may inform gNB2 of the power reduction and/or the value of power reduction applied in the subsequent transmissions.

In another embodiment, gNB2 may indicate to gNB1 that a beam associated with a plurality of time and/or frequency resources causes excessive interference. In one example, gNB2 may indicate an index to a beam pattern entry in the message/IE to gNB1. The beam pattern entry may be included in a beam pattern message/IE that gNB2 has received from gNB1 earlier. gNB2 may further indicate a value of excessive interference, e.g., in dB, by which gNB2 wishes the interference would be lower than measured.

In another example, gNB2 may indicate a plurality of indices to beam pattern entries in the message/IE to gNB1. The beam pattern entries may be included in a beam pattern message/IE that gNB2 has received from gNB1 earlier. For instance, the message/IE from gNB2 may comprise a bitmap field, wherein the length of the bitmap is equal to the number of entries in the message/IE from gNB1. A value of ‘1’ for each bit indicates that an interference associated with an associated entry in the beam pattern message/IE is excessive. gNB2 may further indicate one or more values of excessive interference, e.g., in dB, by which gNB2 wishes the interference would be lower than measured. If one value of excessive interference is indicated, the value may be associated with a minimum, maximum, mean, or average excessive interference associated with all the beam pattern entries with excessive interference. If multiple values of excessive interference are indicated, each the values may be associated with one entry in the beam pattern message/IE.

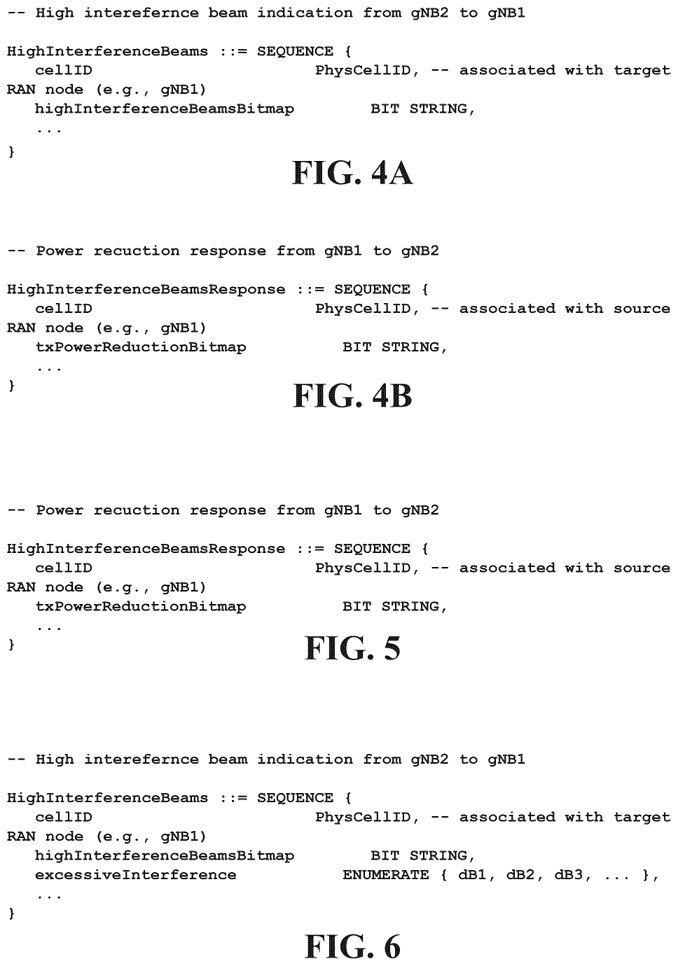

FIGS. 4A-4B present first ASN.1 code examples according to the second embodiment. This IE may be transmitted in a message from the victim network node gNB2 to the aggressor network node gNB1. In response to receiving the message, gNB1 may reduce transmission power on beams whose associated bit in the bitmap field is indicated ‘1’. The power reduction value may be determined by gNB1 or is predetermined. Furthermore, gNB1 may respond to gNB2 by transmitting a message with an indication of power reduction.

FIG. 5 is another example of ASN.1 code. In this example, each bit in the bit string may indicate that a power reduction is applied (e.g., by indicating a value ‘1’) or is not applied (e.g., by indicating a value ‘0’) in subsequent communications. FIG. 6 presents second ASN.1 code examples according to the second embodiment. This IE may be transmitted in a message from the victim network node gNB2 to the aggressor network node gNB1. In response to receiving the message, gNB1 may reduce transmission power, by the indicated value excessiveInterference, on beams whose associated bit in the bitmap field is indicated ‘1’. Furthermore, gNB1 may respond to gNB2 by transmitting a message with an indication of power reduction.

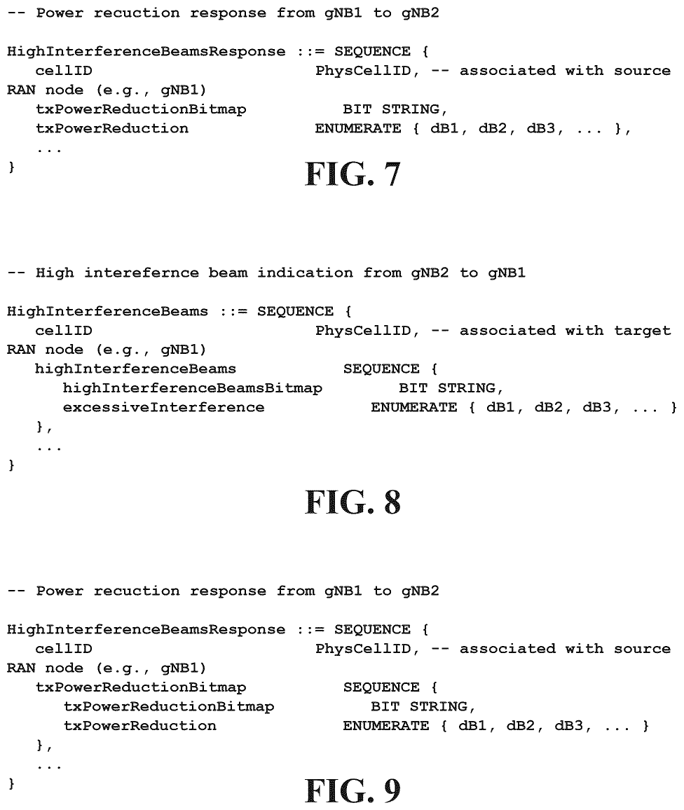

FIG. 7 is another example of ASN.1 code. In this example, each bit in the bit string may indicate that a power reduction equal to txPowerReduction is applied (e.g., by indicating a value ‘1’) or is not applied (e.g., by indicating a value ‘0’) in subsequent communications. This value may or may not be identical to the value indicated by excessiveInterference.

FIG. 8 is yet another example of ASN.1 code according to Embodiment 2. This IE may be transmitted in a message from the victim network node gNB2 to the aggressor network node gNB1. In this example, the HighInterferenceBeams IE may comprise a plurality of bitmap fields and associated values of excessive interference. For example, a first plurality of beams may be indicated to cause an interference in the excess of X dB, a second plurality of beams may be indicated to cause an interference in the excess of Y dB, and so on. In response to receiving the message, gNB1 may reduce transmission power, by the indicated value excessiveInterference, on beams whose associated bit in the associated bitmap field is indicated ‘1’.

Furthermore, according to one or more embodiments, gNB1 may respond to gNB2 by transmitting a message comprising an indication of power reduction. FIG. 9 presents another example of ASN.1 code. In this example, each bit in the bit string may indicate that a power reduction equal to an associated txPowerReduction is applied (e.g., by indicating a value ‘1’) or is not applied (e.g., by indicating a value ‘0’) in subsequent communications. This value may or may not be identical to the value indicated by an associate excessiveInterference.

Additionally, or alternatively, each entry in a high-interference beam indication may comprise one or more of the following:
B: one or more resources in the time domain, e.g., one or more slots, symbols, frames, subframes, etc.,
   B1: an indication of a subcarrier spacing associated with the duration of a slots or symbol;
C: one or more resources in the frequency domain, e.g., one or more PRBs, RBGs, BWPs, etc.,
   C1: an indication of a subcarrier spacing associated with the bandwidth of a PRB, RBS, etc.
      Additional details of the above listed entry components are as follows.

Each entry in the high-interference beam indication may comprise one or more resource(s) in the time domain. For example, an entry may comprise an indication of a time interval indicated by starting and ending points in time in each periodicity, a number of slots, symbols, subframes, or frames in each periodicity, and so on. For example, in a periodicity of 20 slots, one or more entries may indicate a high interference by a beam in slots 0, . . . , 9 and 10, . . . , 19 separately. A value of periodicity may be indicated by the high-interference beam indication, pre-configured by the OAM, specified by the standard, or a combination thereof. The value of periodicity may be negotiated between gNB1 and gNB2 as explained in the third embodiment. If time/duration values are described in units of slots or symbols, an indication of an associated numerology, such as a subcarrier spacing indication, may be included in the message/IE from gNB2 to gNB21 or otherwise indicated to gNB1.

Each entry in the high-interference beam indication may comprise one or more resource(s) in the frequency domain. For example, in addition to association with a carrier frequency, component carrier (CC), bandwidth part (BWP), and/or the like, an entry may comprise an indication of one or more sub-bands indicated by starting and ending PRBs, RBGs, or the like in the frequency domain. For example, in a bandwidth of 100 PRBs, one or more entries may indicate high-interference beams for PRBs 0, . . . , 49 and 50, . . . , 99 separately. If time/duration values are described in units of slots or symbols, an indication of an associated numerology such as a subcarrier spacing indication may be included in the message/IE from gNB2 to gNB1 or otherwise indicated to gNB1.

Periodic versus event-based: The proposed signaling from gNB2 to gNB1 may be periodic, may be triggered by an event, or both. With periodic signaling, gNB2 may send a message/IE to gNB1 periodically, e.g., every X slots and/or every Y data frames, wherein a value of X and/or Y may be specified by the standard, configured by the OAM, configured by an AMF function in the core network, configured by the aggressor network node gNB1, configured by the victim network node gNB2, or a combination thereof. In some realizations, a value of periodicity (X slots and/or Y data frames) may be coordinated according to the third embodiment. With triggering-based signaling, an event may trigger sending a message/IE from gNB2 to gNB1.

In one embodiment, if gNB2 determines that any of the Tx beams of gNB1 causes an excessive interference, gNB2 may send a high-interference beam indication message to gNB1, wherein the message may further indicate a value of excessive interference. An implementation of the event may be described as follows.

```
A network node gNB2 shall:
1> receive, from another network node gNB1, a beam pattern indication
IE comprising a plurality of N beam pattern entries {B₁, B₂, ... , B_{N}};
1> repeat:
  2> perform measurements on the resources associated with {B₁, B₂, ... ,
  B_{N}} to obtain N associated interference estimates {I₁, I₂, ... , I_{N}};
  2> compare each of the interference estimates I₁, I₂, ... , I_{N} with a
  threshold Iₜₕ;
  2> Event X1: if I₁ > Iₜₕ or I₂ > Iₜₕ or ... or I_{N} > Iₜₕ:
    3> send, to gNB1, a high-interference beam indication IE comprising
    one or more of:
```

| | |
|---|---|
| - | a bitmap field {b₁, b₂, ... , b_{N}}, wherein bᵢ = 1 if Iᵢ > Iₜₕ or bᵢ = 0 |
| | otherwise, for all index i; |
| - | a value of max(Iᵢ − Iₜₕ), min(Iᵢ − Iₜₕ), max(Iᵢ/Iₜₕ), min(Iᵢ/Iₜₕ), |
| | mean(Iᵢ) /Iₜₕ, or the like over all index i for which bᵢ = 1, wherein |
| | max(·), min(·), and mean(·) denote maximum, minimum, and |
| | mean/average functions, respectively, and the values of Iᵢ and Iₜₕ |
| | may be in logarithmic or linear scale. |

In another embodiment, in order to reduce signaling overhead, gNB2 may wait until a minimum number of interference estimates exceed the threshold. Then, gNB2 may send a high-interference beam indication message to gNB1, wherein the message may further indicate a value of excessive interference. An implementation of the event may be described as follows.

```
  A network node gNB2 shall:
  1> receive, from another network node gNB1, a beam pattern indication
  IE comprising a plurality of N beam pattern entries {B₁, B₂, ... , B_{N}};
  1> repeat:
    2> perform measurements on the resources associated with {B₁, B₂,
    ... , B_{N}} to obtain N associated interference estimates {I₁, I₂, ... , I_{N}};
    2> compare each of the interference estimates I₁, I₂, ... , I_{N} with a
    threshold Iₜₕ;
    2> Event X2: if Iᵢ > Iₜₕ for at least M values of index i since the latest
    Event X2:
      3> send, to gNB1, a high-interference beam indication IE
      comprising one or more of:
```

| | |
|---|---|
| - | a bitmap field {b₁, b₂, ... , b_{N}}, wherein bᵢ = 1 if Iᵢ > Iₜₕ or bᵢ = 0 |
| | otherwise, for all index i; |
| - | a value of max(Iᵢ − Iₜₕ), min(Iᵢ − Iₜₕ), max(Iᵢ/Iₜₕ), min(Iᵢ/Iₜₕ), |
| | mean(Iᵢ) /Iₜₕ, or the like over all index i for which bᵢ = 1, wherein |
| | max(·), min(·), and mean(·) denote maximum, minimum, and |
| | mean/average functions, respectively, and the values of Iᵢ and Iₜₕ |
| | may be in logarithmic or linear scale. |

The value of M may be determined by signaling or implementation.

In yet another embodiment, a triggering event may be determined based the number of interference estimates exceeding a threshold over a period of P slots or a sliding window of W slots. The event may be described as follows.

```
A network node gNB2 shall:
1> receive, from another network node gNB1, a beam pattern indication
  IE comprising a plurality of N beam pattern entries {B₁, B₂, ... , B_{N}};
1> repeat:
  2> perform, over a period of P slots or a sliding window of W slots,
    measurements on the resources associated with {B₁, B₂, ... , B_{N}}
    to obtain N associated interference estimates {I₁, I₂, ... , I_{N}};
  2> compare each of the interference estimates I₁, I₂, ... , I_{N} with a
  threshold Iₜₕ;
  2> Event X3: if Iᵢ > Iₜₕ for at least 1 (or M) values of index i:
    3> send, to gNB1, a high-interference beam indication IE
      comprising one or more of:
```

| | |
|---|---|
| - | a bitmap field {b₁, b₂, ... , b_{N}}, wherein bᵢ = 1 if Iᵢ > Iₜₕ or bᵢ = 0 |
| | otherwise, for all index i; |
| - | a value of max(Iᵢ − Iₜₕ), min(Iᵢ − Iₜₕ), max(Iᵢ/Iₜₕ), min(Iᵢ/Iₜₕ), |
| | mean(Iᵢ) /Iₜₕ, or the like over all index i for which bᵢ = 1, wherein |
| | max(·), min(·), and mean(·) denote maximum, minimum, and |
| | mean/average functions, respectively, and the values of Iᵢ and Iₜₕ |
| | may be in logarithmic or linear scale. |

Each of the values of M, P, W may be determined by signaling or implementation. P may be the period indicated implicitly or explicitly in association with the beam pattern {B₁, B₂, . . . , B_{N}}.

In yet another realization, multiple instances of an interference estimate exceeding a threshold may trigger the signaling. An implementation of the event may be described as follows.

```
  A network node gNB2 shall:
  1> receive, from another network node gNB1, a beam pattern indication
  IE comprising a plurality of N beam pattern entries {B₁, B₂, ... , B_{N}};
  1> repeat:
    2> perform measurements on the resources associated with {B₁, B₂,
    ... , B_{N}} to obtain N associated interference estimates {I₁, I₂, ... , I_{N}};
    2> compare each of the interference estimates I₁, I₂, ... , I_{N} with a
    threshold Iₜₕ;
    2> Event X4: if Iᵢ > Iₜₕ for at least M instances of Iᵢ for one or more
    values of index i:
      3> send, to gNB1, a high-interference beam indication IE
      comprising one or more of:
```

| | |
|---|---|
| - | a bitmap field {b₁, b₂, ... , b_{N}}, wherein bᵢ = 1 if Iᵢ > Iₜₕ for at |
| | least M instances or bᵢ = 0 otherwise, for all index i; |
| - | a value of max(Iᵢ − Iₜₕ), min(Iᵢ − Iₜₕ), max(Iᵢ/Iₜₕ), min(Iᵢ/Iₜₕ), |
| | mean(Iᵢ) /Iₜₕ, or the like over all index i for which bᵢ = 1, |
| | wherein max(·), min(·), and mean(·) denote maximum, |
| | minimum, and mean/average functions, respectively, and the |
| | values of Iᵢ and Iₜₕ may be in logarithmic or linear scale. |

The value of M may be determined by signaling or implementation.

Interference measurement: In some embodiments, gNB2 may obtain an interference estimate Iᵢ associated with the beam pattern entry Bᵢ by performing a measurement on an associated reference signal, e.g., SSB or CSI-RS, as indicated for the beam pattern entry Bᵢ. The SSB or CSI-RS may be indicated in a beam pattern message/IE from gNB1 according to the first embodiment.

Bandwidth: In one embodiment, the interference may be computed on a whole bandwidth. The bandwidth may be associated with a gNB1 cell on which the SSB or CSI-RS is indicated. In another embodiment, the interference may be computed on a part of the bandwidth associated with the SSB, CSI-RS, or gNB1 cell. For example, if gNB2 uses a part of the bandwidth for receiving uplink signals from one or more UEs, gNB2 may perform interference measurement on the SSB or CSI-RS that overlaps with the said part of the bandwidth.

Rx beam: In some embodiments, gNB2 may perform beamforming when measuring interference on the SSB or CSI-RS. The Rx beam(s) applied by gNB2 to measure interference may be identical to, or otherwise associated with, one or more Rx beams gNB2 uses to receive uplink signals from one or more UEs.

Interference threshold: The interference threshold Iₜₕ may be determined by signaling and/or implementation. In general, the method(s) gNB2 employs to mitigate interference may have an impact on determining the interference threshold. In one embodiment, gNB2 may determine the interference threshold based on a strength of uplink signals from one or more UEs. If the signals are stronger, gNB2 may consider a larger interference threshold. In some embodiments, gNB2 may consider different interference thresholds for obtaining different interference estimates Iᵢ.

The following example is provided in which gNB2 serves UE1, UE2, UE3, and UE4. In this example, gNB2: (i) receives the uplink signals from UE1 and UE2 in a bandwidth BW1, while applying Rx beam RxB1; and (ii) receives the uplink signals from UE3 and UE4 in a bandwidth BW2, while applying Rx beam RxB2. gNB2 receives, from gNB1, a beam pattern message/IE comprising beam pattern entries B1 and B2. In this example, the resources gNB2 considers for receiving uplink signals from UE1 and UE2 overlap with resources associated with B1, while the resources gNB2 considers for receiving uplink signals from UE3 and UE4 overlap with resources associated with B2. Therefore, gNB2 applies Rx beam RxB1 to receive SSB or CSI-RS associated with beam pattern entry B1. gNB2 measures interference from the said CSI-RS or SSB overlapping with the bandwidth BW1. Then, gNB2 compares the obtained interference estimate with a threshold that can potentially be determined based on the uplink signal strength from UE1 and/or UE2. Similarly, gNB2 applies Rx beam RxB2 to receive SSB or CSI-RS associated with beam pattern entry B2. gNB2 measures interference from the said CSI-RS or SSB overlapping with the bandwidth BW2. Then, gNB2 compares the obtained interference estimate with a threshold that can potentially be determined based on the uplink signal strength from UE3 and/or UE4.

According to one aspect, Tx power offset is utilized in beam pattern entry. It may be expected by gNB2 that gNB1 changes the Tx power when transmitting the SSB or CSI-RS according to changes gNB1 may make to the Tx power when transmitting signals associated with a beam pattern entry. However, this may present practical concerns, as described hereafter. One issue is that the Tx power of downlink reference signals, e.g., SSB, may need to be fixed. Changing the Tx power of SSBs dynamically may have an adverse effect on performance for coverage, mobility, and so on. Another issue is that one reference signal may be indicated in multiple beam pattern entries that experience different changes in Tx power. Additionally, or alternatively, the reference signal (e.g., CSI-RS) may be used for other purposes such as CSI acquisition and/or beam training by UEs, mobility management, and the like. In order to address these issues, a beam pattern entry may further comprise an offset value with respect to the Tx power of the indicated reference signal. For example, a beam pattern IE/message from gNB1 may indicate that the Tx power of beam pattern entry B1 has a power offset of X dB with respect to Tx power of SSB1. Then, gNB2 may measure interference on B1 and apply the power offset X dB to obtain an interference estimate associated with the beam pattern entry B1. This parameter is mentioned as parameter D2 in the description of the first embodiment.

Embodiment 3: The present disclosure provides a third embodiment of implementing coordination for beam pattern. According to the first embodiment, a potential aggressor network node gNB1 may send to a potential victim network node gNB2 a beam pattern message/IE comprising information of beamforming gNB1 may apply for transmitting downlink signals. According to the second embodiment, gNB2 may perform interference measurements in association with gNB 1 beams and inform gNB1 of high-interference beams. Then, gNB1 may take interference mitigation actions and may further inform gNB2, implicitly or explicitly, of the actions.

When realizing methods according to the first and second embodiments, each network node (including gNB1 and gNB2 in the above examples) may be both a potential aggressor network node and a victim network node. Based on spatial distribution of UEs in gNB1 and gNB2 cells, and based on traffic load for each UE, which may further be affected by quality-of-service (QoS) requirements, maximum/average data rate, latency needs, etc., each network node may configure a beam pattern of its own and send the information of the beam pattern to other network nodes in the vicinity. Each beam pattern message and/or each high-interference beam indication may add constraints to the spatial Tx filters a network node may apply, which translates to scheduling constraints.

In practice, several network nodes may be potential interferers when employing dynamic TDD. With increasing numbers of small cell network nodes, integrated access and backhaul (IAB) extensions, and future use of network-controlled repeaters, the resulting constraints may leave significantly less flexibility for scheduling, hence not allowing the network to leverage the benefits of dynamic TDD properly. In scenarios where downlink transmission on flexible symbols may result in interference and failure in a nearby cell, the additional flexibility in scheduling may cost the nearby cell precious bandwidth for retransmissions.

Therefore, it may be imperative in some scenarios to allow network nodes to alleviate the effect of increasing constraints that potential interference to and from other cells in the vicinity may introduce. One approach is to allow network nodes to coordinate on beam pattern parameters such that each network node will be able to use certain resources with flexibility with zero or limited remaining constraints.

According to the third embodiment, network nodes may exchange information on an Xn interface in order to coordinate on beam pattern parameters. One example is indicating, according to the second embodiment, which beams in the beam pattern cause a high interference on flexible symbols that the victim network node may use for uplink communications. In response, the target aggressor network node may modify the beam pattern based on the high-interference beam indication from the victim network node and send an updated beam pattern to the victim network node.

In one embodiment, the aggressor network node gNB1 and the victim network node gNB2 may perform signaling to set a periodicity for beam pattern. In one example, gNB1 and gNB2 may intend to set an identical periodicity value. In this example, gNB2 may request, upon receiving a beam pattern indication from gNB1, that gNB1 selects a different beam pattern periodicity value. For example, if gNB1 indicates a periodicity of P1 slots and gNB2 has a periodicity of P2 slots, gNB2 may send to gNB1 a message indicating a request to change the beam pattern periodicity to P2 slots. gNB1 may then take this request into account by selecting a periodicity value identical to P2 slots, an integer multiple of P2, or an integer divisor of P2. In another example, gNB2 may send the message requesting a periodicity value prior to receiving a beam pattern indication from gNB1.

In yet another example, gNB1 and gNB2 may intend to set different periodicity values. For instance, if periodicity values of one or more of the following are different: (i) a TDD pattern of a gNB1 cell; (ii) a TDD pattern of a gNB2 cell; (iii) a beam pattern of the gNB1 cell; and (iv) a beam pattern of the gNB2 cell, the resulting pattern may allow a larger number of Tx and Rx beam combinations in gNB1 and gNB2 cells on flexible symbols in the gNB1 cell and/or the gNB2 cell. In this example, if gNB1 indicates a periodicity of P1 slots and gNB2 has also a periodicity of P1 slots (or an integer multiple or divisor of P1 slots), gNB2 may send to gNB1 a message indicating a request to change the beam pattern periodicity to a different value. gNB1 may then take this request into account by selecting a different periodicity value. In another example, gNB2 may send the message requesting a different periodicity value prior to receiving a beam pattern indication from gNB1.

In some examples, the beam pattern periodicity may be indicated or considered in absolute time units, such as milliseconds, rather than in units of slots or symbols. This may particularly be important when network nodes use different values of subcarrier spacing and/or other numerology parameters.

In another embodiment, network nodes may coordinate on other parameters. Consider the example that a network node gNB2 is in the vicinity of two other network nodes gNB1 and gNB3. In this example, gNB1 and gNB3 may not interfere with each other, and hence, they may not introduce beam pattern constraints directly. However, both network nodes may interfere with gNB2 communications. gNB2 may communicate with UEs that are spatially closer to gNB1 when there is a large interference from gNB3, and vice versa: gNB2 schedule communications with UEs that are spatially closer to gNB3 when there is a large interference from gNB1. However, since there is no direct coordination between gNB1 and gNB3, the two constraints may significantly limit gNB2's options for scheduling communications with all the UEs served by the gNB2 cell. Therefore, having received beam pattern indication from gNB1 and gNB3, gNB2 may send a message to either gNB1 or gNB3 indicating a request to change the beam pattern so as to alleviate the interference constraints. The request may comprise an indication that two or more beam patterns be swapped. gNB1 or gNB3 may then respond by indicating an updated beam pattern and/or indicating that the gNB2's request was accepted.

By extension, gNB2 may send a message/IE to gNB1, in response to receiving a beam pattern indication from gNB1, wherein the message/IE may indicate a desirable permutation of beam pattern entries in the gNB1's beam pattern that would allow gNB2 to schedule communications with less constraints or more flexibility.

In one example, gNB1 may send to gNB2 a beam pattern indication comprising a set of beam pattern entries {B₁, B₂, B₃, B₄}. In response, gNB2 may send to gNB1 a message/IE comprising a sequence of indices {1, 4, 3, 2}. This indicates to gNB1 that gNB2 requests to use a beam associated with B₂ on resources associated with B₄, and vice versa. The resources may be in time and/or frequency domains. For instance, if gNB1 has indicated that it uses Tx beams TxB1, TxB2, TxB3, TxB4 on slots 2, 5, 6, 9 respectively, the message/IE from gNB2 may ask gNB1 to use TxB1, TxB4, TxB3, TxB2 on slots 2, 5, 6, 9 respectively. A similar method may be employed for beam patterns in association with frequency resources, e.g., a plurality of PRBs instead of slots, or with joint time-frequency resources, e.g., a plurality of PRBs on one or more slots.

Embodiment 4: In one aspect, the present disclosure provides for enhanced TDD configuration signaling. Various embodiments of the present disclosure comprise signaling between aggressor and victim base stations as well as signaling among their respective subscriber devices and associated behaviors. In several scenarios, signaling and behaviors are defined based on determining potential aggressor entities and victim entities.

In practice, a cellular system normally comprises several base stations (and other network nodes) deployed in a certain area. The density of the deployed network nodes may highly depend on the local traffic demand, the scattering environment, and other related parameters, which lead to a significantly higher density in crowded urban areas.

As a result, it may not be practical to determine which base stations are potentially aggressors or victims in an interference scenario. Indeed, due to wireless channel reciprocity, each base station may be an aggressor gNB and a victim gNB simultaneously, while in the presence of a large number of base stations in an area, each pair of base stations may introduce additional constraints for beam management, power control, link adaptation, scheduling, and so on.

One approach assumes that base stations may be clustered based on their mutual interference levels, and base stations in each cluster may follow an identical TDD pattern, or otherwise coordinate to mitigate interference. This approach raises practical issues, from identifying cell clusters that can be assumed isolated from the rest of the system (in the sense of mutual interference) to signaling for coordinating a TDD pattern that is suitable for the traffic demands in all the cells that the base stations provide.

Furthermore, at high frequencies such as frequency range 2 (FR2) millimeter-wave (mmWave) bands, beamforming introduces an additional constraint that must be handled properly in order to mitigate potentially severe interference, due to beam conflicts, while avoiding pessimistic (worst-case) interference estimation that may lead to suboptimal scheduling and underutilization of dynamic TDD.

In various embodiments, base stations may communicate beam/spatial information with other base stations in the vicinity in order to obtain interference estimates associated with different Tx beams of each base station. Then, base stations coordinate on TDD patterns for beams that may cause an excessive interference on other communications in the vicinity.

Two extreme cases are as follows:
(i) Case 1: No high-interference beams. In this case, each base station may configure a TDD pattern without constraints imposed by neighboring base stations due to interference;
(ii) Case 2: All beams interfering. Conversely, in this case, all beams of a base station may cause an excessive interference on a cell from neighboring base station. Therefore, the TDD pattern should be tightly coordinated among the base station and its neighboring base stations.

In practice, in a typical deployment scenario, it is expected to observe a relationship between beamforming and interference that falls between the above two extreme cases. In some embodiments, base stations in a vicinity may exchange the following signaling for beam based TDD coordination. The following steps are provided.

Step 1: A first base station gNB1 may send beam/spatial information to a second base station gNB2. The beam/spatial information may comprise an indication of associations between one or multiple Tx beams and one or multiple reference signals. Each reference signal may be an SSB or a CSI-RS.

Step 2: Having received the beam/spatial information, gNB2 may perform measurements on the reference signals in order to obtain estimates of interference from associated Tx beams. The gNB2 may configure UEs served by gNB2 with interference measurement and reporting to obtain gNB-to-UE inter-cell interference as well.

Step 3: gNB2 sends to gNB1 a message/report comprising information of which Tx beams cause a large interference on gNB2 cell's communication. The message/report may comprise, for example, a bitmap field wherein each bit indicates whether an associated Tx beam of gNB2 causes an excessive interference. As another example, a value of inter-node (inter-BS, inter-gNB) interference may be indicated in association with each Tx beam of gNB1. As yet another example, a value of excess inter-node interference (e.g., in dB) may be indicated in association with each Tx beam of gNB1.

Step 4: In response to the said message/report, gNB1 may send to gNB2 information of a TDD pattern associated with the Tx beams that cause a large interference according to the message/report.

Furthermore, due to mobility of the UEs that each base station serves as well as potential changes in the scattering environment, which may change the footprint of each Tx beam, it is beneficial to introduce the following additional signaling that enables a dynamic coordination.

Step 5: gNB2 may invoke a new round of interference estimation and TDD coordination by signaling to gNB1.

In response to step 5, gNB1 may send beam/spatial information to gNB2, transmit the reference signals while applying the associated Tx beams, indicate a TDD pattern associated with high-interference beams, or a combination thereof.

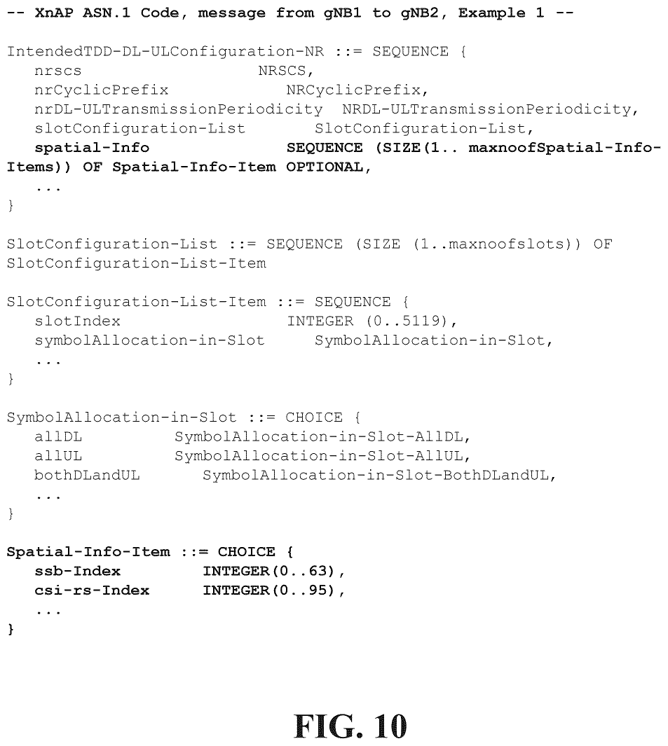

FIG. 10 is an example ASN.1 code for the beam/spatial-based TDD pattern indication according to step 4 of the above method. In this example, beam/spatial information are optionally added to the Intended TDD-DL-UL Configuration IE. Bracketed ellipsis [ . . . ] denotes possibly omitted code. Bolded font code shows the additional code introduced herein.

According to this example, if an Intended TDD-DL-UL Configuration IE comprises an optional spatial/beam information parameter spatial-Info, the receiving RAN node gNB2 may assume that the comprised TDD pattern (indicated by the parameter slotConfiguration-List) is applicable to the gNB1 Tx beams associated with the reference signal indices (SSB indices, CSI-RS indices, etc.) listed in the parameter spatial-Info.

As a result, gNB2 may expect multiple such TDD configuration IEs, each comprising indication of a potentially different TDD pattern associated with one or multiple reference signal indices.

In one embodiment, gNB2 may not expect to receive different TDD patterns for a reference signal index. In this case, if gNB2 receives more than one TDD pattern for a reference signal index, it may handle the issue by implementation.

In another embodiment, if gNB2 receives more than one TDD pattern for a reference signal index, it may consider the TDD pattern that is received most recently. This embodiment is particularly useful in dynamic coordination scenarios where a RAN node such as gNB1 changes TDD patterns according to the information it may dynamically receive from neighboring base stations as well as traffic demands in a gNB1 cell that may change over time.

In yet another embodiment, if gNB2 receives more than one TDD pattern for a reference signal index, it may combine information of the multiple TDD patterns in association with the reference signal index.

With respect to an Intended TDD-DL-UL Configuration IE not comprising spatial information, in some realizations, gNB2 may consider the TDD pattern indicated by the comprised slotConfiguration-List for the remaining beams, i.e., beams (reference signal indices) no associated with another TDD pattern.

Alternatively, in some realizations, upon receiving an Intended TDD-DL-UL Configuration IE not comprising spatial information, gNB2 may assume that indicated TDD pattern is applicable to all beams. In some examples, gNB2 may assume that indicated TDD pattern is applicable to all beams only if gNB2 receives the Intended TDD-DL-UL Configuration IE with no spatial information more recently than spatial/beam-based TDD patterns. This may be used to reset all previously received spatial/beam based TDD patterns.

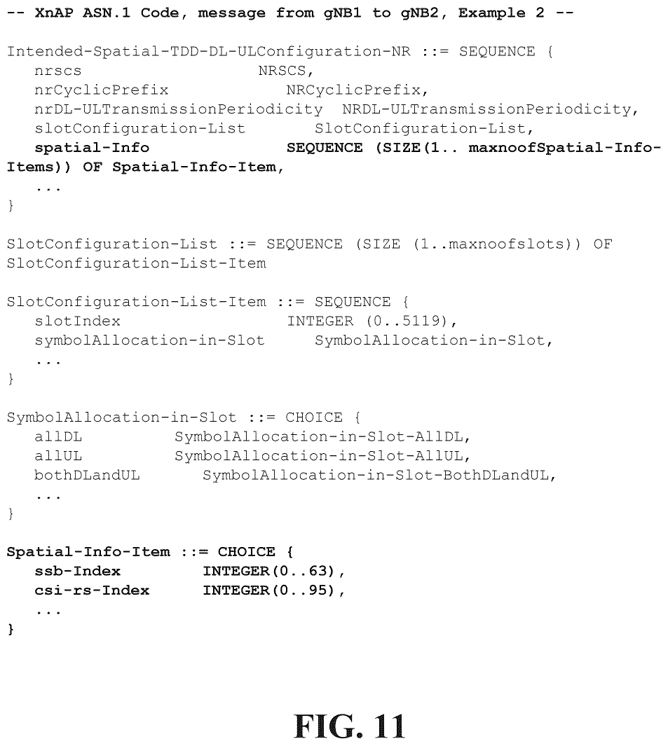

FIG. 11 is another example ASN.1 code for the message in step 4. In this example, a new TDD configuration IE is introduced. Bracketed ellipsis [ . . . ] denotes possibly omitted code. Bolded font code shows the new code introduced herein.

According to this example, if a RAN node gNB2 receives an Intended Spatial TDD-DL-UL Configuration IE, gNB2 may assume that the comprised TDD pattern (indicated by the parameter slotConfiguration-List) is applicable to the gNB1 Tx beams associated with the reference signal indices (SSB indices, CSI-RS indices, etc.) listed in the parameter spatial-Info.

In one embodiment, information from an Intended Spatial TDD-DL-UL Configuration IE overrides that of an Intended Spatial TDD-DL-UL Configuration IE with no spatial information, i.e., if slotConfiguration-List in the former IE and slotConfiguration-List in the latter IE indicate a TDD pattern for a same slot, gNB2 may neglect the latter.

In another embodiment, an Intended Spatial TDD-DL-UL Configuration IE with no spatial information overrides any previously received Intended Spatial TDD-DL-UL Configuration IE. This may be used to reset all previously received spatial/beam based TDD patterns.

Furthermore, in some embodiments, an Intended TDD-DL-UL Configuration IE or an Intended Spatial TDD-DL-UL Configuration IE may comprise additional information such as associated frequency resources and Tx power information.

In some embodiment, an Intended TDD-DL-UL Configuration IE or an Intended Spatial TDD-DL-UL Configuration IE may optionally comprise a plurality of frequency resources, such as a set of PRBs, to which the TDD pattern or the spatial/beam-based TDD pattern, indicated by SlotConfiguration-List, is applicable. The frequency resources may be indicated by a starting PRB index and a number of PRBs, a frequency range, or the like.

In some embodiment, an Intended TDD-DL-UL Configuration IE or an Intended Spatial TDD-DL-UL Configuration IE may optionally comprise a Tx power parameter such as a Tx power offset, e.g., in dB, with respect to a reference signal. In one realization, a reference signal may be indicated along the Tx power offset. In another realization, or if a reference signal index is not indicated along the Tx power offset, the receiving node gNB2 may assume that the Tx power offset is indicated with respect to a reference signal indicated by an associated Spatial-Info or Spatial-Info-Item.

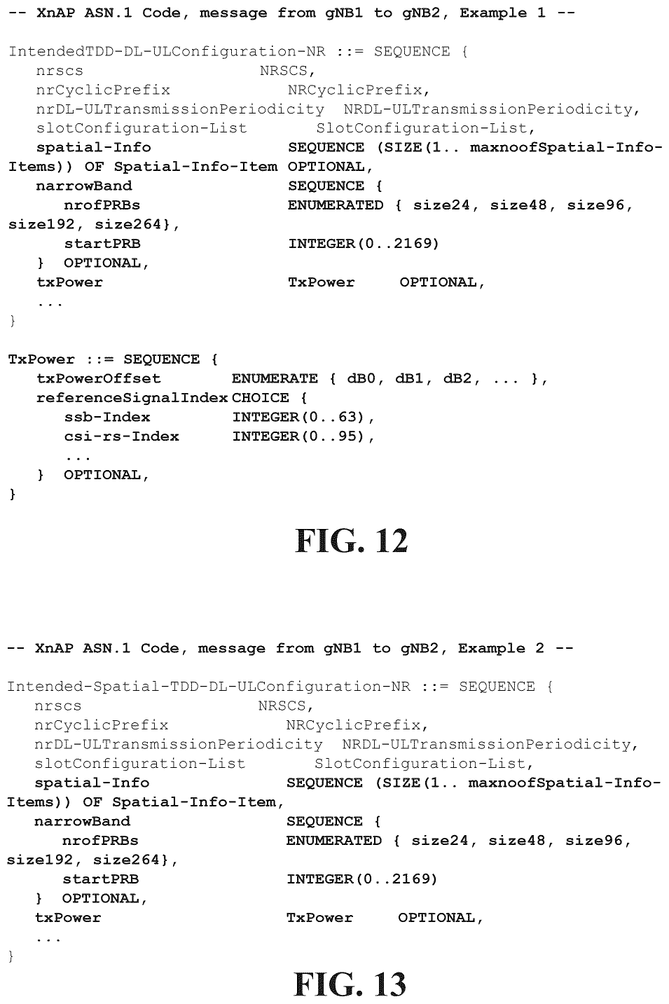

FIG. 12 provides first examples of ASN.1 code according to the described embodiments. FIG. 13 provides additional examples of ASN.1 code according to the described embodiments. Rules similar to the ones described for overlapping/conflicting configuration IEs may apply to the frequency resource/range parameter (narrowBand) and/or the Tx power parameter. In one embodiment, information of a more recently received IE may override information from a less recent configuration for overlapping beams, slots/symbols, and/or frequency range. In another embodiment, a configuration IE with no spatial/beam, time, and/or frequency parameter may override previously received configuration IEs comprising spatial/beam, time, and/or frequency parameters for the beam(s), slot(s)/symbol(s), and/or frequency range(s) indicated by the latter.

Embodiment 5: Alternative embodiments are presented that provide communication through NG interface. The first, second, and third embodiments are described with emphasis on inter-base-station communications via Xn interfaces. The Xn interface is the standard interface specified for direct backhaul communication among gNBs. However, similar methods may be employed by using other interfaces and means of communication. For example, signaling to/from an LTE base station (eNB) may be performed over an X2 interface. Similarly, communication with other radio access technologies (RATs) may be performed on other similar interfaces. Furthermore, other than direct base station signaling, similar methods may be employed on NG interfaces (or S1 interfaces in LTE) through the core network. In some embodiments, when direct communication among base stations does not exist, or otherwise is not preferred, signaling similar to the proposed Xn signaling may be performed on an NG interface.

According to a first embodiment of providing inter-base station communication through NG interface, a base station gNB1 may send a beam pattern indication to the core network, e.g., an access and mobility function (AMF) in the core network, through an NG interface. The AMF may then send the information of the beam pattern indication to other base stations gNB2, gNB3, etc. The target base station(s) gNB2, gNB3, etc. may be indicated explicitly or implicitly by the signaling from gNB1. In one example, the beam pattern indication message may comprise identifiers (IDs) of target base stations gNB2, gNB3, etc., which is an example of an explicit indication.

In another example, the AMF may send the beam pattern information to target base stations gNB2, gNB3, etc., based on geographical locations of the target base stations and the source base station gNB1. In this example, the AMF may select target base stations that are closer to the source base station than a distance threshold, as those target base stations may be more likely to be exposed to interference form the source base station.

In yet another example, the AMF may send the beam pattern information from a macro base station to nearby small cell base stations, or vice versa. In this example, the AMF may assume that interference among macro base stations is not significant due to sufficient spatial separation and proper antenna orientations.

In several embodiments, the AMF may further process the information instead of merely forwarding it. In some examples, the AMF may combine information of several beam pattern indications from one or more base stations and send the combined information to target base stations.

For example, the AMF may receive beam pattern indications from gNB1, gNB2, gNB3. Then, the AMF combines information of beam pattern indications from gNB1 and gNB2 for gNB3, from gNB2 and gNB3 for gNB1, and from gNB3 and gNB1 for gNB2. In this example, each beam pattern entry for target base station gNB2 may comprise information from associated beam pattern entries in signaling from gNB1 and gNB3.

According to a second embodiment of providing inter-base station communication through NG interface, information of individual gNBs may not be forwarded to a target base station. Instead, mapping between beam pattern entries and gNB IDs may be stored in the AMF. The mapping information may then be used if the target base station indicates high-interference beams to the AMF. In this case, the AMF may use the mapping information to forward the high-interference beam information back to the interfering base stations. For example, if gNB2 indicates high-interference beams associated with a beam pattern indication that comprises a combination of the beam pattern information from gNB1 and gNB3, the AMF may use the mapping information to forward the high-interference beam information from gNB2 back to gNB1, gNB3, or both.

According to a third embodiment of providing inter-base station communication through NG interface, signaling for beam pattern coordination may also occur on the NG interface. In this case, instead of direct signaling among base stations on an Xn interface, signaling may be performed over NG interfaces through the core network such as an AMF.

Furthermore, the AMF (or another core network function) may manage, or otherwise assist with, setting beam pattern parameters. In one example, the AMF may send to one or more base stations messages comprising indications of beam pattern parameters such as periodicity values. The AMF may choose to indicate identical or different values of beam pattern periodicity to assist with mitigating interference or increasing scheduling flexibility for one or more base stations. In another example, the AMF may further send indications to change one or more beam pattern parameters upon receiving high-interference beam indications from a base station. In yet another example, upon receiving a high-interference beam indication from a victim base station, the AMF may indicate to one or more aggressor base stations to swap or permute beam pattern entries so as to mitigate the interference to the victim base station.

Embodiment 7: According to yet another aspect of the disclosure, an alternate embodiment is provided that involves transmitting SRS for unified CLI/ICI measurements. In the preceding description of the first, second, and third embodiments, emphasis is made on using downlink reference signals such as SSB and CSI-RS for the purpose of beam pattern indication and interference measurement. These embodiments are provided as the main scope of the present disclosure is inter-base-station cross-link interference (CLI) management, and base stations normally transmit in the downlink, hence the emphasis on downlink reference signals. However, it is possible to configure an uplink reference signal such as a sounding reference signal (SRS) for transmission by a base station. This approach may provide at least the following advantages.

One advantage is that the victim base station may perform uplink measurements only for the purpose of measuring channels from UEs that the victim base station serves (UE-to-BS channel), measuring interference from UEs that other base stations serve (UE-to-BS interference), and measuring interference from aggressor base stations (BS-to-BS interference). This may provide a unified channel and interference measurement at the victim base station.

A similar advantageous unified approach is also enabled at the UEs served by the victim base station, which are referred to as victim UEs herein. Signaling for UE-to-UE cross-link interference (CLI) measurements are specified through which a UE may be provided SRS configurations on which to perform measurements and obtain SRS-RSRP (reference signal receive power) as a measure of UE-to-UE CLI. The CLI may be from other UE in the same cell or in a different cell. The UE may then report the SRS-RSRP to the serving base station. Hence, if the aggressor base station transmits SRS, a victim UE may reuse the currently specified signaling for obtaining both UE-to-UE CLI and BS-to-UE inter-cell interference (ICI) in a unified manner.

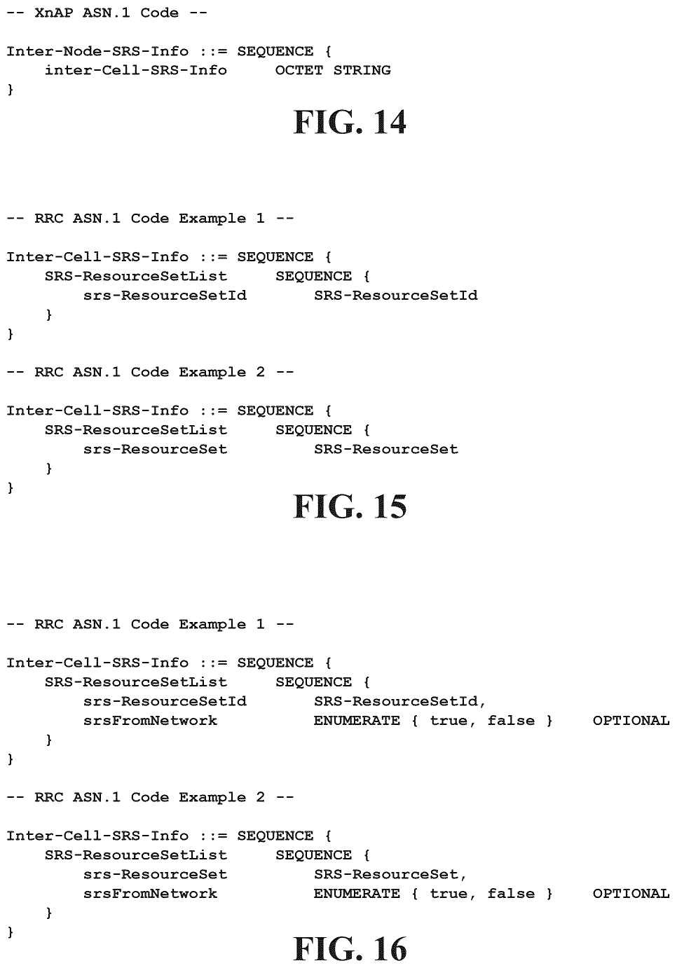

In some embodiments, a base station gNB1 may configure SRS for the purpose of CLI and/or ICI measurements in a cell. Information of the SRS configuration may then be sent to a victim base station gNB2. The information may be included within a beam pattern message/IE as described for the first embodiment. Then, gNB2 may perform measurements on the SRS for the purpose of inter-gNB CLI management. Additionally, or alternatively, gNB2 may send the SRS configuration information, included within an SRS-RSRP reporting configuration, to a UE that gNB2 is serving for the purpose of BS-to-UE ICI management. In these embodiments, FIG. 14 is an RRC configuration comprising SRS configuration/resource information may be encapsulated as an octet string in an XnAP IE Inter-Node-SRS-Info as follows.

Examples of the RRC IE inter-Cell-SRS-Info are as follows. In one embodiment, gNB1 may configure SRS for the purpose of CLI and/or ICI measurements in a cell and send the information to gNB2, but gNB1 may not indicate to gNB2 that an SRS is from a base station or a UE. gNB2 may then perform interference measurement on the SRS to obtain an interference estimate, possibly without regards to the source of the interference. This is reasonable in a dynamic TDD system wherein resources are shared between uplink and downlink dynamically and indiscriminately, as far as other base stations are concerned.

FIG. 15 provides example ASN.1 codes for an RRC configuration according to this embodiment. Bracketed ellipsis [ . . . ] denotes possibly omitted code. Bolded font code shows the code introduced herein. In another embodiment, gNB1 may additionally indicate to gNB2 that an SRS is from a base station. The message/IE from gNB1 to gNB2 may comprise the following information: (i) SRS configuration (sequence parameters, SRS resource, etc.); and (ii) an indication of whether the SRS is transmitted by a BS or a UE. gNB2 may then perform interference measurement on the SRS to obtain an interference estimate for inter-gNB CLI management.

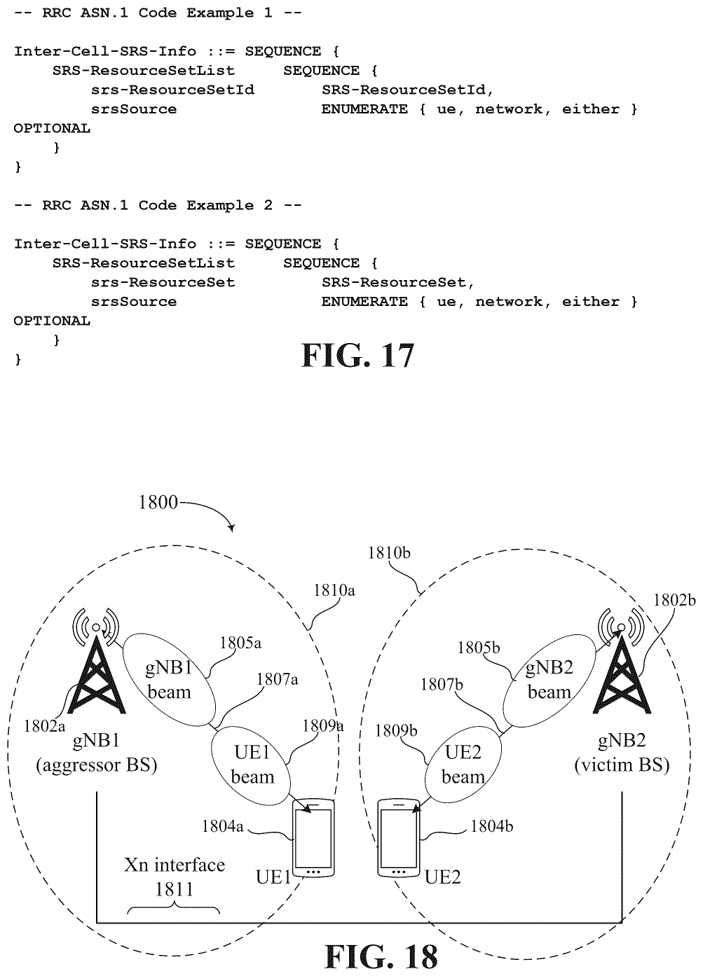

FIG. 16 provides example ASN.1 codes for an RRC configuration according to this embodiment. Bracketed ellipsis [ . . . ] denotes possibly omitted code. Bolded font code shows the additional code introduced herein. In the above examples, the new parameter srsFromNetwork may optionally indicate to the target base station (gNB2) whether the associated SRS configuration/resource is to be transmitted by a network node (here, gBN1). If the value is ‘true’, gNB2 may assume that the associated SRS is configured for inter-gNB CLI measurements. But if the value is ‘false’, gNB2 may assume that the associated SRS is configured for UE-to-gNB ICI measurements. If the parameter is absent, gNB2 may assume a default value of ‘true’ of ‘false’. FIG. 17 presents an alternative ASN.1 example, where an optional parameter srsSource may indicate whether to expect an associated SRS from a UE, a base station (network), or either.

In yet another embodiment, gNB1 may configure one or more SRSs that share resources in time or frequency domains, but which are distinguished by one or more other parameters such as a ‘transmission comb’ or a ‘cyclic shift’. Each of the multiple SRSs may then be used by gNB1 or a UE served by gNB1 for the purpose of interference measurement in another cell. gNB1 may transmit the SRS or signal to the UE to transmit the SRS.

In one aspect, the present disclosure provides transmitting SRS as inter-cell OTA indication of slot format. In some embodiments, one or multiple SRSs may be associated with one or multiple flexible symbols/slots. If an aggressor base station (gNB1) determines to use any or all of the one or multiple flexible symbols/slots for downlink, gNB1 may transmit the SRS. However, if gNB1 determines to use any or all of the one or multiple flexible symbols/slots for an uplink communication, it may signal a UE to transmit the SRS. In this case, gNB1 may signal the particular UE that uses the flexible symbols/slots for the said uplink communication. Alternatively, if the UE served by gNB1 determines to use any or all of the one of multiple flexible symbols/slots for uplink, the UE may transmit the SRS without an indication from gNB1.

This approach to use an SRS by either the base station or the UE to indicate whether a flexible resource is downlink or uplink may further be considered an instance of OTA indication. Methods based on OTA indications are proposed in Embodiment 5.

Examples of using flexible symbols/slots for downlink is scheduling a PDSCH, transmitting a slot format indicator (SFI) indicating that the flexible symbols/slots are downlink, and so on. Similarly, examples of using flexible symbols/slots for uplink is scheduling a PUSCH, transmitting a slot format indicator (SFI) indicating that the flexible symbols/slots are uplink, and so on.

In some embodiments, the UE may be configured to automatically transmit the SRS upon determining that the associated one or multiple flexible symbols/slots are indicated uplink. Examples of such indication is receiving a DCI scheduling a PUSCH on the flexible symbols/slots, receiving an SFI indicating that the flexible symbols/slots are uplink, and so on.

The reason for adopting this approach is that internal indication of slot format within a cell occurs very quickly through transmission of slot format indication (SFI) messages at the physical layer. However, conveying this information over the backhaul (for example, an on an Xn interface) may introduce a long delay, for example, in the order of tens or hundreds of slots, which is too long for a scheduling that meets dynamic traffic demands. An OTA indication of this sort among base stations may reduce this delay to a few slots, hence improving responsiveness of the system to dynamic changes in the traffic that may result in highly variable inert-cell cross-link interference.

FIG. 18 is an example scenario of a communication environment 1800 for inter-cell OTA indication of slot format. In this example scenario, a first base station gNB1 1802a serves a first subscriber device UE1 1804a via a potentially aggressor cell 1810a; and a second base station gNB2 1804b serves a second subscriber device UE2 1804b via a potentially victim cell 1810b. It should be noted that in a typical cellular system, there may be several base stations in a cell where each base station may provide cells that are potentially aggressor, victim, or both. In an inter-cell cross-link interference scenario, each of gNB1 1802a and UE1 1804a is considered potentially an aggressor, and each of gNB2 1802b and UE2 1804b is considered potentially a victim.

The first base station gNB1 1802a is configured to direct a gNB1 beam 1805a toward the first subscriber device UE1 1804a to communication on a Cell1 Uu link 1807a. UE1 1804a is configured to direct a UE1 beam 1809a toward the first base station gNB1 1802a to communicate on the Cell1 Uu link 1807a. The second base station gNB2 1802b is configured to direct a gNB2 beam 1805b toward the second subscriber device UE1 1804b to communication on a Cell2 Uu link 1807b. The second subscriber device UE2 1804a is configured to direct a UE2 beam 1809b toward the second base station gNB2 1802b to communicate on the Cell2 Uu link 1807b. The first base station gNB1 1802a and the second base station gNB2 1802b communicate via Xn/NG backhaul (“Xn interface”) 1811.

With dynamic TDD, flexible symbols/slots may be used for either downlink (when gNB1 1802a transmits to UE1 1804a) or uplink (when UE1 1804a transmits to gNB1 1802a). This is determined dynamically in a dynamic TDD system, and hence, the victim entities gNB2 1802b and/or UE2 1804b may not be aware in advance whether to expect an interference from gNB1 1802a or UE1 1804a. The difference may be significant as it may determine the direction of interfering signals, the strength of the interference, and other such characteristics. The proposed inter-cell OTA indication addresses this problem.

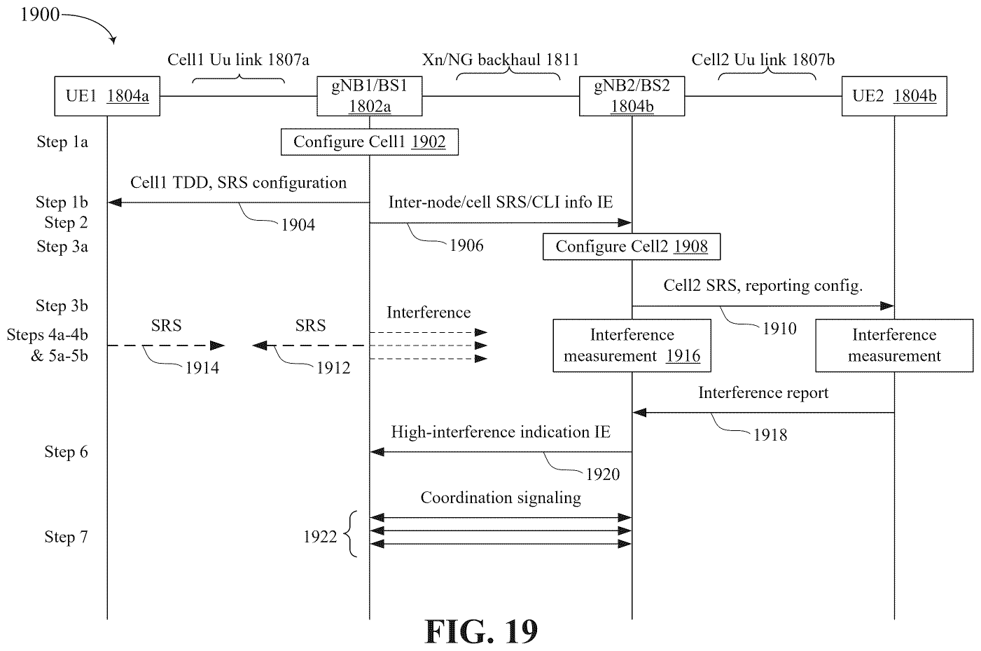

In one or more embodiments, FIG. 19 is a timing diagram that presents a method 1900 that is employed by the various entities in the example scenario. At 1902, Step 1a: gNB1 may configure one or multiple flexible symbols/slots on a first cell Cell1 for communication with one or multiple UEs such as UE1. The configuration may be an RRC configuration, such as a TDD-UL-DL-ConfigCommon and/or TDD-UL-DL-ConfigDedicated. gNB1 may send information of the flexible symbol/slot configuration to UEs such as UE1.

At 1904, Step 1b: gNB1 may configure one or multiple SRSs on Cell1 in association with the one or multiple flexible symbols/slots. The configuration may be an RRC configuration. gNB1 may send information of the SRS configuration, along with an indication associating the SRS configuration with the one or multiple slots, to UEs such as UE1.

At 1906, Step 2: gNB1 may send information of the flexible symbols/slots and the SRS(s) to gNB2 over a backhaul interface. The backhaul interface may be a direct backhaul link between gNB1 and gNB2, such as Xn interface, or an indirect backhaul link, such as an NG interface through a core network function, e.g., an AMF. The backhaul message/IE may, which conveys the information, may comprise configurations parameters from the RRC layer and/or the NG layer.

At 1908, Step 3a: Upon receiving the said information, gNB2 may configure one or multiple SRSs on a second cell Cell2, wherein resources configured for the Cell2 SRSs are identical to, or overlap with, resources configured for the Cell1 SRSs. The configuration may be an RRC configuration. gNB2 may send information of the SRS configuration to UEs such as UE2.

At 1910, Step 3b: gNB2 may further configure a reporting based on measurements on the Cell2 SRS, such as an SRS-RSRP reporting. The configuration may be an RRC configuration. gNB2 may send information of the SRS configuration to UEs such as UE2.

At 1912, Step 4a: Next, gNB1 may determine whether any or all the one or multiple flexible symbols/slots are to be used for a downlink communication. If affirmative, gNB1 may transmit an SRS according to the Cell1 SRS configuration on the Cell1 SRS resources.

At 1914, Step 4b: Similarly, UE1 may determine whether any or all the one or multiple flexible symbols/slots are to be used for an uplink communication. If affirmative, UE1 may transmit an SRS according to the Cell1 SRS configuration on the Cell1 SRS resources.

At 1916, Step 5a: Simultaneously, gNB2 may perform a measurement on the Cell2 SRS resources, which are identical to, or overlap with, the Cell1 SRS resources in order to obtain an estimate of the interference on the one or multiple flexible symbols/slots.

At 1918, Step 5b: Similarly, gNB2 may perform a measurement on the Cell2 SRS resources, which are identical to, or overlap with, the Cell1 SRS resources in order to obtain an estimate of the interference on the one or multiple flexible symbols/slots. The interference estimate may be an SRS-RSRP according to the reporting configuration. UE2 may then transmit to gNB2 a report message comprising the interference estimate, such as the SRS-RSRP, according to the reporting configuration.

At 1920, Step 6: Based on the gNB2 interference estimate and/or the UE2 interference report, gNB2 may send a message/IE to gNB1, wherein the message/IE may comprise an indication of high interference.

At 1922, Step 7: gNB1 and gNB2 may further coordinate, through additional signaling, to mitigate interference.

Details and alternative embodiments and realizations are as follows. In some embodiments, the inter-node/cell SRS/CLI IE in step 2 may comprise information of reference signals, associated beams, associated resources, and the like. In some realizations, the IE(s) may comprise a beam pattern indication as described in several embodiments of this disclosure.

In some embodiments, in step 4, the SRS(s) may be transmitted by gNB1, UE1, or both based on determining whether an associated flexible symbol/slot F is used for a downlink communication or an uplink communication. In some realizations, upon determining that a flexible symbol/slot F is used for downlink, gNB1 may transmit an SRS on a same SRS resource on which gNB1 has configured the SRS for UE1 in association with F. In this case, gNB2 or UE2 may not distinguish between an interference from gNB1 and UE1.

Alternatively, in some realizations, gNB1 may use a different resource R1 as the SRS resource R2 on which gNB1 has configured the SRS for UE1 in association with F. In this case, gNB2 or UE2 may be able to distinguish between an interference from gNB1 and UE1 based on determining whether the SRS was received on R1 or R2, respectively. In order to enable this distinction, the inter-node/cell SRS/CLI info IE may comprise a parameter indicating whether an SRS is resource is associated with a network node (base station, gNB) transmission or a UE transmission, respectively.

In some embodiments, UE1 may transmit an SRS upon determining that an associated flexible symbol/slot F is to be used for an uplink communication. The determining may be based on receiving a DCI scheduling a PUSCH on F, receiving an SFI indicating that F is an uplink symbol/slot, and so on. In some realizations, the determining may comprise determining that a symbol/slot overlapping with F, a superset of F, or a subset of F is used for an uplink communication.

In the said embodiments, UE1 may not receive an explicit indication such as an SRS triggering DCI to transmit the SRS. In this case, the condition to transmit an SRS (e.g., determining that an associated flexible symbol/slot is used for uplink) may be referred to as an implicit SRS triggering condition. Additionally, or alternatively, in some realizations, UE1 may receive an explicit indication to transmit the SRS.

In some embodiments, upon determining that a flexible symbol/slot F is to be used for a downlink communication with UE1, gNB1 may apply a transmission beam B associated with downlink communications with UE1. In this case, gNB1 may apply the same beam B for the said downlink communication. In some realizations, gNB1 may not change the beam for the said downlink communication even if the beam B becomes obsolete and a different beam B′ is determined for downlink communications to UE1. In one example, gNB1 may still use the beam B for the said downlink communication on F. In another example, gNB1 may cancel the said downlink communication.

In some embodiments, upon determining that a flexible symbol/slot F is to be used for an uplink communication, UE1 may apply a transmission beam B associated with uplink communications with gNB1. In this case, UE1 may apply the same beam B for the said uplink communication.

In some realizations, once UE1 transmits the SRS while applying the beam B, UE1 may refuse to apply a different beam for the said uplink communication even if the beam B becomes obsolete by the time of the said uplink communication. In one example, UE1 may still use the beam B for the said uplink communication on F. In another example, if UE1 receives an indication of a different uplink beam B′, e.g., a different SRS resource indicator (SRI), UE1 may neglect the indication of B′ and apply the beam B for the said uplink communication. In yet another example, UE1 may not transmit the said uplink communication. In yet another example, UE1 may assume that the said uplink communication is canceled. In yet another example, gNB1 may cancel the said uplink communication.

It should be noted that a slot format indication (SFI), which is a signaling that may indicate a direction of communication (downlink or uplink) to UEs is transmitted on a group-common physical downlink control channel (GC-PDCCH). As a consequence, multiple UEs may receive an indication from gNB1 that a flexible symbol/slot F is used for an uplink communication, while it may not be determined immediately which of the UEs is going to transmit on F. In this case, all the UEs receiving the SFI may transmit SRS, which may raise problems. For example, this may result in a pessimistic (worst-case) interference estimation by gNB2 and/or UE2. As another example, the SRSs may collide and, as a result, not allow an appropriate interference estimation.

In order to address this issue, in some embodiments, UE1 may consider additional SRS triggering conditions.

In one embodiment, UE1 may not transmit SRS upon receiving an SFI indicating that an associated flexible symbol/slot F is indicated UL. Instead, UE1 may only consider PUSCH scheduling or the like, which is UE-specific and not UE-group specific, as an SRS triggering condition. Whether to consider SFI as an SRS triggering condition may be specified by the standard or configured by the network (gNB1).

In another embodiment, UE1 may consider its buffer status as an additional SRS triggering condition. In this case, if UE1 does not have data in its buffer, it may assume that the said indication in the SFI is not intended for UE1. Then, UE1 may not transmit the SRS associated with the flexible symbol/slot F.

In yet another embodiment, UE1 may receive an additional indication of whether the SFI is intended for UE1. gNB1 may transmit the indication to UE1 in order to avoid an SRS triggering at UE1.

In yet another embodiment, an indication from gNB1 may activate or deactivate SRS triggering in association with a flexible symbol/slot F. gNB1 may use this indication to allow or disallow UE1 to automatically transmit an SRS upon determining that F is used for an uplink communication. The activation/deactivation signaling may be a physical layer signal such as a DCI, a MAC CE signaling, a semi-static activation/deactivation by an RRC signaling, or the like.

In step 4, gNB2 may apply a receive (Rx) beam when listening to the SRS resources and performing interference measurements, wherein the Rx beam may be identical to the Rx beam used for receiving an uplink communication from UE2.

Similarly, in step 4, UE2 may apply a receive (Rx) beam when listening to the SRS resources and performing interference measurements, wherein the Rx beam may be identical to the Rx beam used for receiving a downlink communication from gNB2. In one example, UE2 may apply an Rx beam identical to the latest Rx beam indicated or determined for uplink communication to gNB2. In another example, UE2 may receive an indication of the Rx beam to apply when performing the interference measurement.

For the interference reporting in step 5, a reporting similar to the SRS-RSRP reporting specified in 3GPP Rel-16 may be adopted. The SRS-RSRP reporting configuration, in this case, may comprise an additional indication that the SRS-RSRP measurement is associated with an inter-cell/gNB CLI, an inter-cell UE-to-UE CLI, a gNB-to-UE CLI, a beamformed CLI, and the like.

The high-interference indication IE in step 6 may follow similar principles and details described in Embodiment 2 or other embodiments proposed in the present disclosure. The coordination signaling in step 7 may follow similar principles and details described in Embodiments 2, 3 or other embodiments proposed in the present disclosure.

In obtaining SRS timing for CLI measurement, generally, a UE acquires SRS timing information by implementation. No signaling or behavior is specified to assist the UE with timing acquisition, which could improve interference estimation performance. However, when a base station transmits SRS, it is possible to improve timing acquisition with negligible signaling overhead. In some embodiments, a source base station gNB1 may indicate, to a target base station gNB2, an association between an SRS configured for CLI/ICI measurements and a downlink reference signal such as an SSB. Then, gNB2 or a UE served by gNB2 may acquire timing by detecting the SSB and use the timing to obtain RSRP of the SRS.

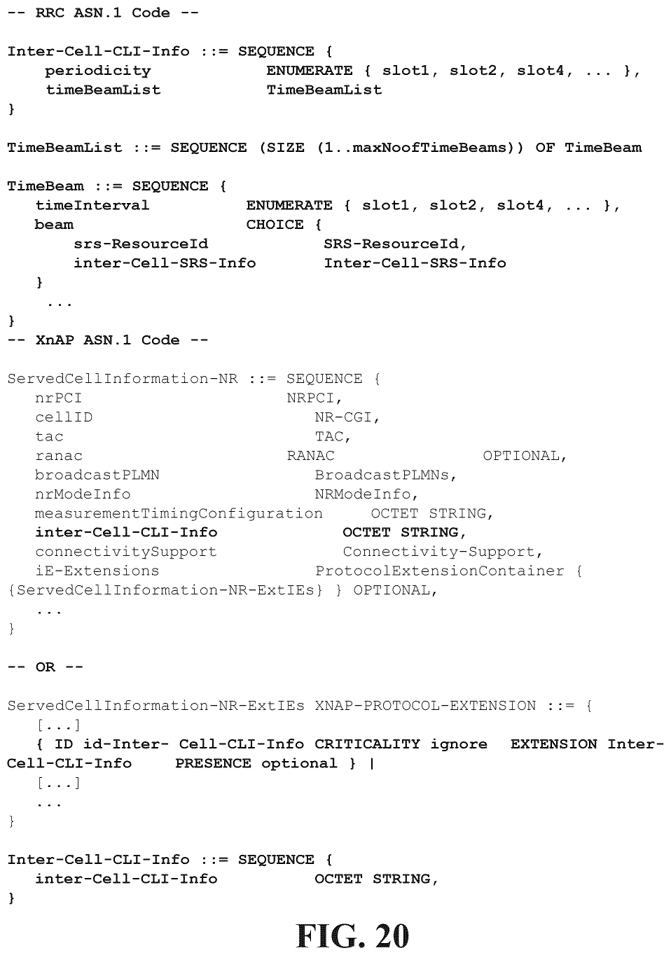

In one aspect, the present disclosure provides beam pattern indication by SRS. In some embodiments, similar to the beam pattern indication in Embodiment 1, each SRS configuration may be indicated to be associated with a beam. A beam pattern indication may comprise beam pattern entries, each further comprising information of associated time-frequency resources, transmission power, and so on. FIG. 20 is an example ASN.1 code for this realization. Bracketed ellipsis [ . . . ] denotes possibly omitted code. Bold font code shows the additional code introduced herein.

In this example, the TimeBeamList IE is configured by the RRC in gNB1 and passed to the NG layer as a string of octets. The octet string is then transmitted on an Xn interface to gNB2 where it is passed back to the RRC layer and decoded.

In response to receiving the message/IE, gNB2 may take interference mitigation actions such as scheduling, link adaptation, etc. while taking the information in the message/IE into account. Additionally, or alternatively, gNB2 may perform interference measurements and report high interference beams to gNB1 as proposed in Embodiment 2.

In another realization, information of reference signal such as reference signal resources are passed from gNB1 to gNB2 in an RRC IE encapsulated in an XnAP IE. In this case, reference to reference signal indices defined in the RRC IE may be made in the XnAP IE.

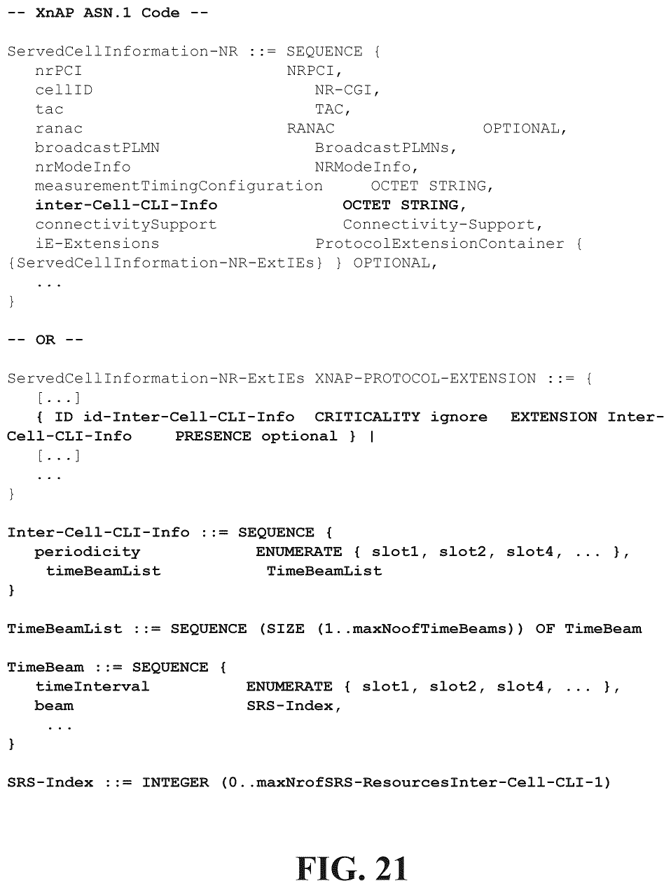

FIG. 21 is an example of an ASN.1 code. The above realizations are essentially different in which layer configures which parameters. In the first realization, both the reference signal configuration and the beam pattern are indicated by the RRC, while the XnAP IE encapsulates the RRC IE as a string of bits or octets. In the second realization, the reference signals are configured by the RRC, while the XnAP configures the beam pattern.

However, it is expected that the two realizations result in a relatively similar implementation as both configurations are expected to be performed in a central unit (CU) of the source base station gNB1. Similarly, the RRC and XnAP configurations are normally processed at a CU of the destination/target base station gNB2, hence resulting in relatively similar implementation.

Therefore, several embodiments of the present disclosure are described without necessarily specifying whether certain parameters are configured in an RRC IE, an XnAP IE, a combination thereof, or the like. For each embodiment, realization, or example, it should be appreciated that parameters conveying the information may be configured at one or multiple entities/layers.

In some embodiments, each entry in a beam pattern (for a serving cell) may comprise one or multiple of the following:
A: one or multiple beam indices, e.g.:
   A1: one or multiple reference signal indices,
   A2: one or multiple QCL relationships,
   A3: one or multiple DL/UL TCI states;
B: one or multiple resources in the time domain, e.g., one or multiple slots, symbols, frames, subframes, etc.;
   B1: an indication of a subcarrier spacing associated with the duration of a slots or symbol;
   B2 a time pattern (e.g., a periodic time pattern, possibly along a valid duration for the periodic time pattern, or a bit map valid for a certain duration);
C: one or multiple resources in the frequency domain, e.g., one or multiple PRBs, RBGs, BWPs, etc.;
   C1: an indication of a subcarrier spacing associated with the bandwidth of a PRB, RBG, etc.;
D: one or multiple indications of a transmission power, e.g.:
   D1: one or multiple transmission power values with reference to a baseline, e.g., an SRS index,
   D2: one or multiple offset values with respect to the baseline, for example in dB,
   D3: one or multiple indications of whether a transmission power is higher or lower than one or multiple thresholds.
      Details may follow those of the parameters described for Embodiment 1.

Embodiment 6: A sixth embodiment of the disclosure provides Over-the-air (OTA) indications. In the first through fourth embodiments, signaling for cross-link interference (CLI) management among base stations is performed on backhaul interfaces such as Xn/X2 and NG/S1. These interfaces are typically realized as wired backhauls, which may introduce latency and overhead constraints. However, in order to utilize benefits of dynamic TDD efficiently, it is desirable for a system of multiple base stations to communicate dynamic DL/UL assignments, beam assignments, etc., according to instantaneous traffic demands and scheduling requests. These scheduling-related assignments may be highly dynamic given the larger available bandwidth at higher frequencies and, consequently, the potentially more “bursty” traffic per user and overall. This type of dynamic communication may not be feasible or practical on backhaul interfaces.

According to the sixth embodiment, over-the-air (OTA) indications may be used additionally, or alternatively, to communicate information related to dynamic scheduling-related assignments, resource allocation, beam management, and so on. In some embodiments, a base station gNB1 may configure a reference signal (RS) such as a CSI-RS in association with a beam, a plurality of resources, and the like. Then, if gNB1 intends to apply the associated beam and/or use the plurality of resources, gNB1 transmits the RS, informing other base stations of its intention. In response, the other base stations may detect the RS and take interference mitigation measures accordingly. For the sake of brevity, the RS used for this purpose, which may be a CSI-RS or the like, is referred to as OTA-RS herein.

In one embodiment, a base station gNB1 sends to another base station gNB2 a beam pattern message/IE comprising a plurality of beam pattern entries. Each beam pattern entry may comprise indications of one or more beams, a plurality of resources, Tx power offset indications, and so on, as described in the first embodiment. Furthermore, each one or more beam pattern entries may comprise an indication to an OTA-RS. Through this signaling, gNB1 indicates to gNB2 that if the OTA-RS is detected in association with a beam pattern entry, one or more of the following may apply: (i) if the beam pattern entry comprises a beam indication, detecting the OTA-RS from gNB1 implies that gNB1 intends to use the indicated beam; (ii) if the beam pattern entry comprises an indication of a plurality of resources in time and/or frequency domains, detecting the OTA-RS from gNB1 implies that gNB1 intends to use one or more of the plurality of resources; and (iii) if the beam pattern entry comprises a Tx power/offset indication, detecting the OTA-RS from gNB1 implies that gNB1 intends to apply the Tx power/offset.

If multiple of the above conditions hold, they may hold jointly. For example, detecting an OTA-RS from a base station may imply that the base station intends to use a plurality of time-frequency resources to transmit DL signals while applying a certain beam and a certain Tx power offset with respect to a reference Tx power.

In response to receiving the beam pattern indication, gNB2 may monitor transmission of an OTA-RS. If gNB2 detects the OTA-RS, gNB2 may take interference mitigation measures accordingly, e.g., avoid scheduling an uplink communication that may be impacted by the potential interference, cancel an upcoming uplink communication (e.g., a PUSCH), and the like.

In practice, an OTA-RS, such as a CSI-RS, may be configured on periodic resources, for example on certain symbols of certain slots in a periodicity of P slots. Then, each “instance” of OTA-RS transmission in a period of P slots may indicate applying an associated beam, using a plurality of resources, and/or applying an associated Tx power in that period of P slots. As an alternative, an OTA-RS transmission may indicate a possible use of any or all of the associated beams and resources for multiple periods of P slots. The number of periods of P slots may be determined by the transmitting and/or receiving base stations, by a base station configuration, OAM configuration, dynamic indication, or the like.

In one embodiment, the OTA-RS may be identical to a reference signal (such as a CSI-RS or SSB) indicated in the associated beam pattern entry. For example, if a beam pattern entry Bᵢ comprises an indication of a CSI-RS for indicating a beam and/or interference estimation, the target base station gNB2 may infer, upon not detecting the CSI-RS, that the associated beams and/or resources indicated in the beam pattern entry Bᵢ is not to be used and, therefore, no interference is expected from the associated source base station gNB1. This may be referred to as implicit indication or implicit inference.

In another embodiment, upon not detecting an OTA-RS instance, the target base station gNB2 may infer that no interference is expected from the source base station gNB1 on the associated beams and/or resources for one or more periods of P slots. Then, upon detecting an OTA-RS instance at another time, gNB2 may infer that interference may be expected (or may not be guaranteed to not exist) on one or more periods of P slots.

In yet another embodiment, upon not detecting an OTA-RS instance, the target (victim) base station gNB2 may infer that no interference is expected from the source (aggressor) base station gNB1 on the associated beams and/or resources for one or more periods of P slots only if the OTA-RS is an SSB. In this case, gNB2 may not make a similar inference if the OTA-RS is a CSI-RS.

Conversely, in yet another embodiment, upon not detecting an OTA-RS instance, the target base station gNB2 may infer that no interference is expected from the source base station gNB1 on the associated beams and/or resources for one or more periods of P slots only if the OTA-RS is a CSI-RS. In this case, gNB2 may not make a similar inference if the OTA-RS is an SSB.

In some embodiments, gNB2 may make the inference based on a configuration parameter of the OTA-RS. In one embodiment, gNB2 may make the inference if the OTA-RS is not indicated ‘periodic’. In another embodiment, gNB2 may make the inference if the OTA-RS is not indicated ‘periodic’ or ‘semi-persistent’. In yet another embodiment, gNB2 may make the inference if the OTA-RS is indicated ‘aperiodic’. In yet another embodiment, gNB2 may make the inference if the OTA-RS is indicated a new type such as ‘ota’, ‘ota-indication’, or the like.

In some embodiments, indication of an OTA-RS may be explicit, e.g., included within the beam pattern message/IE. In one embodiment, each beam pattern entry may comprise an indication of an OTA-RS, such as a CSI-RS. Then, the target base station gNB2 may monitor (listen) to the resources associated with the OTA-RS. Upon detecting the OTA-RS, gNB2 may determine that it expects interference from the source base station gNB1 in association with the beams and/or resources indicated by the beam pattern entry in one or more of P slots.

In another embodiment, a new parameter may indicate that a reference signal such as a CSI-RS is of type ‘OTA Indication’. Then, if the target base station gNB2 receives a beam pattern entry with the CSI-RS indicated for one or more associated beams, gNB2 may additionally consider detecting or not detecting the CSI-RS as a signal for determining whether gNB2 expects interference from the source base station gNB1 on the one or more beams. Upon not detecting the CSI-RS, gNB2 may determine that gNB2 does not expect interference from the source base station gNB1 in association with the beams and/or resources indicated by the beam pattern entry in one or more of P slots.

In an example, gNB2 may not expect gNB1 to cause interference/transmit on the indicated resources/beams earlier than a certain time from the time the OTA-RS is received. The said certain time can be set to at least a minimum time gap required between a PDCCH indicating cancellation of a UL signal and the UL signal to be cancelled.

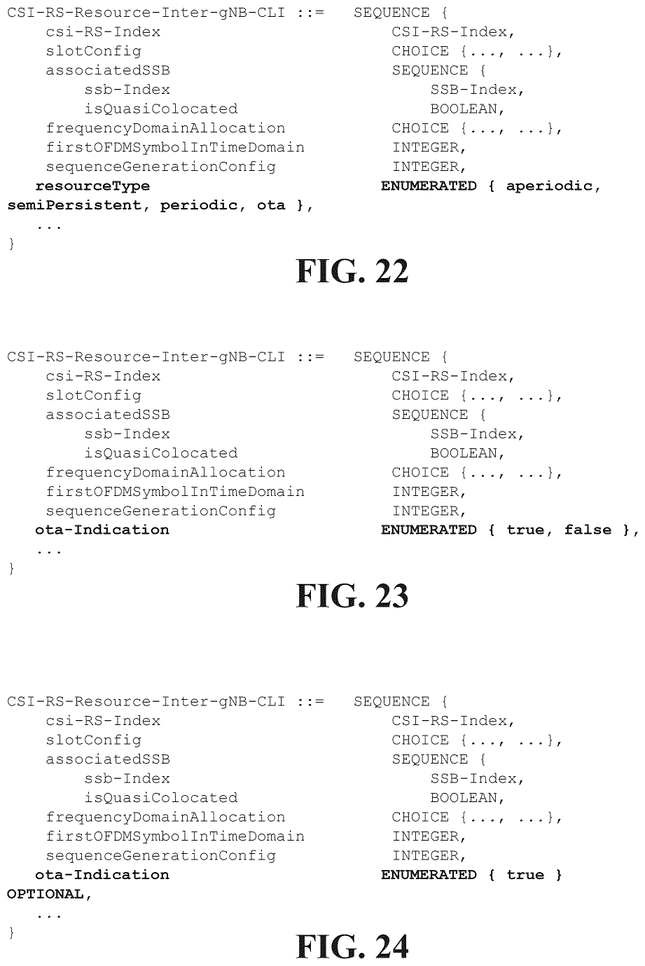

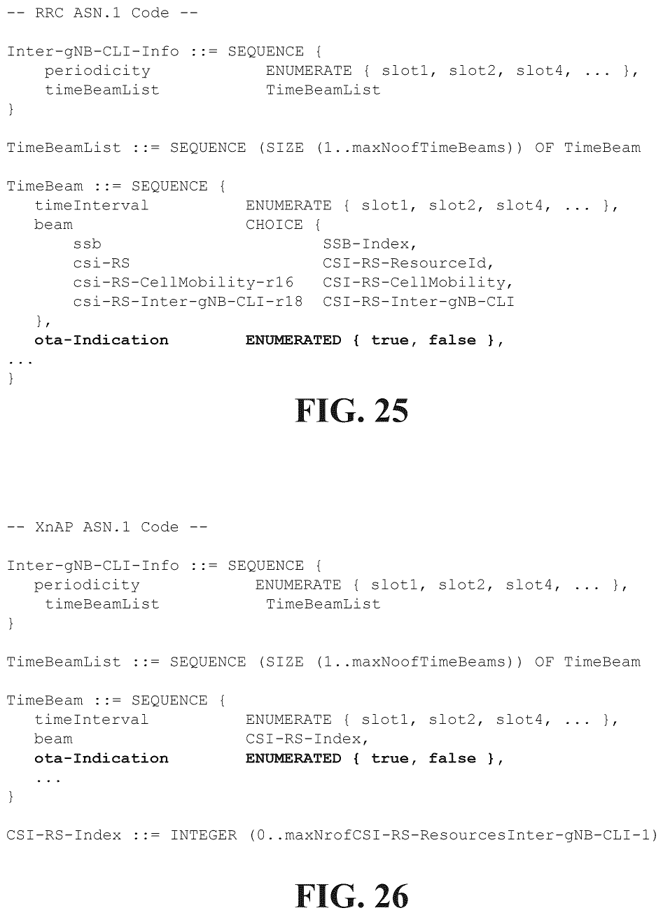

FIGS. 22-26 presents examples of ASN.1 code to realize the aforementioned embodiments. In each of the examples provided below, Bolded font code shows the additional code introduced on top of an example code presented for the first embodiment. FIG. 22 illustrates a first example in which a new parameter resourceType is introduced that is defined as enumerated type with one or more values ‘aperiodic’, ‘semiPersistent’, ‘periodic’, and ‘ota’. FIG. 23 presents a second example in which a new parameter indicates whether the CSI-RS is used for OTA indication. FIG. 24 is another realization of a similar concept as FIG. 23. In FIG. 24, the parameter may take only one value, but the parameter itself is optional. FIG. 25 presents another example in which an explicit indication is included within the beam pattern entry RRC IE. FIG. 26 presents another example in which an explicit indication is included within the beam pattern entry Xn IE.

According to one aspect providing OTA indication on a different cell, the reference signals for beam indication, power offset indication, interference measurement, etc., according to the proposed methods are normally configured on the same cell as the cell on which the associated (interfering) communication may occur. For example, when an aggressor base station gNB1 sends a beam pattern indication to a victim base station gNB2, the CSI-RS that gNB1 configures for beam and power indication for a DL communication (e.g., a PDSCH) is normally on the same cell as the cell on which the DL communication occurs. This is due to the fact that the wireless channel on the ground is highly frequency-selective, and hence measurements on reference signals in one frequency may not provide a correct estimate of the potential interference in another frequency.

This is, however, not the case for OTA indication. The goal with OTA indication is to provide the target base station with information of whether the target base station should expect interference. In one embodiment, the result of measurement on an OTA indication reference signal may be one of two possible outcomes: ‘detected’ or ‘not detected’. Detection of the reference signal may be interpreted as a warning for an upcoming interference. In this case, accuracy of measurements is not a main concern, as the process is provided for detection, not estimation. As a result, a reference signal for OTA indication (OTA-RS) may be configured on a different cell.

In one example, an OTA-RS may be configured on a same cell as the target cell, i.e., the cell on which the associated communication such as a PDSCH or PDCCH transmission may occur. The two cells may be in the same frequency band. In another example, an OTA-RS may be configured on a frequency band that is different from the frequency band on which the target cell is configured. In particular, it may be beneficial to configure an OTA-RS on a cell in frequency range 1 (FR1), which provides higher reliability for detection, and indicate the OTA-RS for communication on a target cell that is configured in frequency range 2 (FR2).

In yet another example, an OTA-RS may be configured in one cell and indicated for communication in the same and/or multiple other cells. In yet another example, an OTA-RS may be transmitted by a radio unit that is not collocated with the radio unit that transmits signals of a target cell on which an associated communication occurs. In yet another example, an OTA-RS may be configured on a master cell group (MCG) in association with a communication on a secondary cell group (SCG). Conversely, an OTA-RS may be configured on an SCG in association with a communication on an MCG. In yet another example, an OTA-RS may be configured on a Special Cell (SpCell) in association with a communication on another cell of the same cell group. The SpCell is a Primary Cell (PCell) of a Master Cell Group (MCG) or Secondary Cell Group (SCG).

Some aspects of the disclosure include a consideration of antenna panel, antenna port, quasi-collocation, TCI state, and spatial relation. In some embodiments, the terms antenna, panel, and antenna panel are used interchangeably. An antenna panel may be a hardware that is used for transmitting and/or receiving radio signals at frequencies lower than 6 GHz, e.g., frequency range 1 (FR1), or higher than 6 GHz, e.g., frequency range 2 (FR2) or millimeter wave (mmWave). In some embodiments, an antenna panel may comprise an array of antenna elements, where each antenna element is connected to hardware such as a phase shifter that allows a control module to apply spatial parameters for transmission and/or reception of signals. The resulting radiation pattern may be called a beam, which may or may not be unimodal and may allow the device (e.g., UE, node) to amplify signals that are transmitted or received from one or more spatial directions.

In some embodiments, an antenna panel may or may not be virtualized as an antenna port in the specifications. An antenna panel may be connected to a baseband processing module through a radio frequency (RF) chain for each of transmission (egress) and reception (ingress) directions. A capability of a device, in terms of the number of antenna panels, their duplexing capabilities, their beamforming capabilities, and so on, may or may not be transparent to other devices. In some embodiments, capability information may be communicated via signaling or, in some embodiments, capability information may be provided to devices without a need for signaling. In the case that such information is available to other devices, such as a CU, the information can be used for signaling or local decision making.

In some embodiments, an antenna panel may be a physical or logical antenna array comprising a set of antenna elements or antenna ports that share a common or a significant portion of an RF chain (e.g., in-phase/quadrature (I/Q) modulator, analog to digital (A/D) converter, local oscillator, phase shift network). The antenna panel may be a logical entity with physical antennas mapped to the logical entity. The mapping of physical antennas to the logical entity may be up to implementation. Communicating (receiving or transmitting) on at least a subset of antenna elements or antenna ports active for radiating energy (also referred to herein as active elements) of an antenna panel requires biasing or powering on of the RF chain, which results in current drain or power consumption in the device (e.g., node) associated with the antenna panel. This power consumption includes power amplifier/low noise amplifier (LNA) power consumption associated with the antenna elements or antenna ports. The phrase “active for radiating energy,” as used herein, is not meant to be limited to a transmit function but also encompasses a receive function. Accordingly, an antenna element that is active for radiating energy may be coupled to a transmitter to transmit radio frequency energy or to a receiver to receive radio frequency energy, either simultaneously or sequentially, or may be coupled to a transceiver in general, for performing its intended functionality. Communicating on the active elements of an antenna panel enables generation of radiation patterns or beams.

In some embodiments, depending on implementation, a “panel” can have at least one of the following functionalities as an operational role: Unit of antenna group having a Tx beam that is independently controlled; Unit of antenna group having transmission power that is independently controlled; and Unit of antenna group having transmission timing that is independently controlled. The “panel” may be transparent to another node (e.g., next hop neighbor node). For certain condition(s), another node or network entity can assume the mapping between device's physical antennas to the logical entity “panel” may not be changed. For example, the condition may be assumed to continue until the next update or report from device. For another example, the network entity may assume that there will be no change to the mapping condition for a predefined duration of time. The device may report its capability with respect to the “panel” to the network entity. The device capability may include at least the number of “panels”. In one implementation, the device may support transmission from one beam within a panel. With multiple panels, more than one beam (one beam per panel) may be used for transmission. In another implementation, more than one beam per panel may be supported/used for transmission.

In some of the embodiments described, an antenna port is defined such that the channel over which a symbol on the antenna port is conveyed can be inferred from the channel over which another symbol on the same antenna port is conveyed.

Two antenna ports are said to be quasi co-located (QCL) if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, average delay, and spatial Rx parameters. Two antenna ports may be quasi-located with respect to a subset of the large-scale properties, and different subset of large-scale properties may be indicated by a QCL Type. The QCL Type can indicate which channel properties are the same between the two reference signals (e.g., on the two antenna ports). Thus, the reference signals can be linked to each other with respect to what the device can assume about their channel statistics or QCL properties. For example, qcl-Type may take one of the following values and other qcl-Types may be defined based on combination of one or more large-scale properties: (i) ‘QCL-TypeA’: {Doppler shift, Doppler spread, average delay, delay spread}; (ii) ‘QCL-TypeB’: {Doppler shift, Doppler spread}; (iii) ‘QCL-TypeC’: {Doppler shift, average delay}; and (iv) ‘QCL-TypeD’: {Spatial Rx parameter}.

Spatial Rx parameters may include one or more of: angle of arrival (AoA,) Dominant AoA, average AoA, angular spread, Power Angular Spectrum (PAS) of AoA, average AoD (angle of departure), PAS of AoD, transmit/receive channel correlation, transmit/receive beamforming, spatial channel correlation, etc.

The QCL-TypeA, QCL-TypeB and QCL-TypeC may be applicable for all carrier frequencies, but the QCL-TypeD may be applicable only in higher carrier frequencies (e.g., mmWave, FR2 and beyond), where essentially the device may not be able to perform omni-directional transmission. That is, the device would need to form beams for directional transmission. With a QCL-TypeD between two reference signals A and B, the reference signal A is considered to be spatially co-located with reference signal B and the device may assume that the reference signals A and B can be received with the same spatial filter (e.g., with the same RX beamforming weights).

An “antenna port” according to an embodiment may be a logical port that may correspond to a beam (resulting from beamforming) or may correspond to a physical antenna on a device. In some embodiments, a physical antenna may map directly to a single antenna port, in which an antenna port corresponds to an actual physical antenna. Alternately, a set or subset of physical antennas, or antenna set or antenna array or antenna sub-array, may be mapped to one or more antenna ports after applying complex weights, a cyclic delay, or both, to the signal on each physical antenna. The physical antenna set may have antennas from a single module or panel or from multiple modules or panels. The weights may be fixed as in an antenna virtualization scheme, such as cyclic delay diversity (CDD). The procedure used to derive antenna ports from physical antennas may be specific to a device implementation and transparent to other devices.

In some of the embodiments described, a TCI-state (Transmission Configuration Indication) associated with a target transmission can indicate parameters for configuring a quasi-collocation relationship between the target transmission (e.g., target RS of DM-RS ports of the target transmission during a transmission occasion) and a source reference signal(s) (e.g., SSB/CSI-RS/SRS) with respect to quasi co-location type parameter(s) indicated in the corresponding TCI state. The TCI describes which reference signals are used as QCL source, and what QCL properties can be derived from each reference signal. A device can receive a configuration of a plurality of transmission configuration indicator states for a serving cell for transmissions on the serving cell (e.g., between a serving gNB and a smart repeater). In some of the embodiments described, a TCI state comprises at least one source RS to provide a reference (device assumption) for determining QCL and/or spatial filter.

In some of the embodiments described, a UL TCI state is provided if a device is configured with separate DL/UL TCI by RRC signaling. The UL TCI state may comprise a source reference signal, which provides a reference for determining UL spatial domain transmission filter for the UL transmission (e.g., dynamic-grant/configured-grant based PUSCH, dedicated PUCCH resources) in a CC or across a set of configured CCs/BWPs.

In some of the embodiments described, a joint DL/UL TCI state is provided if the device is configured with joint DL/UL TCI by RRC signaling (e.g., configuration of joint TCI or separate DL/UL TCI is based on RRC signaling). The joint DL/UL TCI state refers to at least a common source reference RS used for determining both the DL QCL information and the UL spatial transmission filter. The source RS determined from the indicated joint (or common) TCI state provides QCL Type-D indication (e.g., for device-dedicated PDCCH/PDSCH) and is used to determine UL spatial transmission filter (e.g., for UE-dedicated PUSCH/PUCCH) for a CC or across a set of configured CCs/BWPs. In one example, the UL spatial transmission filter is derived from the RS of DL QCL Type D in the joint TCI state. The spatial setting of the UL transmission may be according to the spatial relation with a reference to the source RS configured with qcl-Type set to ‘typeD’ in the joint TCI state.

In some of the embodiments described, a spatial relation information associated with a target transmission can indicate parameters for configuring a spatial setting between the target transmission and a reference RS (e.g., SSB/CSI-RS/SRS). For example, the device may transmit the target transmission with the same spatial domain filter used for reception of the reference RS (e.g., DL RS such as SSB/CSI-RS). In another example, the device may transmit the target transmission with the same spatial domain transmission filter used for the transmission of the reference RS (e.g., UL RS such as SRS). A device can receive a configuration of a plurality of spatial relation information configurations for a serving cell for transmissions on the serving cell.

In some of the embodiments described, a UL TCI state is provided if a device is configured with separate DL/UL TCI by RRC signaling. The UL TCI state may comprise a source reference signal, which provides a reference for determining UL spatial domain transmission filter for the UL transmission (e.g., dynamic-grant/configured-grant based PUSCH, dedicated PUCCH resources) in a CC or across a set of configured CCs/BWPs.

In some of the embodiments described, a joint DL/UL TCI state is provided if the device is configured with joint DL/UL TCI by RRC signaling (e.g., configuration of joint TCI or separate DL/UL TCI is based on RRC signaling). The joint DL/UL TCI state refers to at least a common source reference RS used for determining both the DL QCL information and the UL spatial transmission filter. The source RS determined from the indicated joint (or common) TCI state provides QCL Type-D indication (e.g., for device-dedicated PDCCH/PDSCH) and is used to determine UL spatial transmission filter (e.g., for UE-dedicated PUSCH/PUCCH) for a CC or across a set of configured CCs/BWPs. In one example, the UL spatial transmission filter is derived from the RS of DL QCL Type D in the joint TCI state. The spatial setting of the UL transmission may be according to the spatial relation with a reference to the source RS configured with qcl-Type set to ‘typeD’ in the joint TCI state.

The different steps described for the example embodiments, in the text and in the flowcharts, may be permuted. Each configuration may be provided by one or more configurations in practice. An earlier configuration may provide a subset of parameters while a later configuration may provide another subset of parameters. Alternatively, a later configuration may override values provided by an earlier configuration or a pre-configuration.

A configuration may be provided by a radio resource control (RRC) signaling, a medium-access control (MAC) signaling, a physical layer signaling such as a downlink control information (DCI) message, a combination thereof, or other methods. A configuration may include a pre-configuration, or a semi-static configuration provided by the standard, by the vendor, and/or by the network/operator. Each parameter value received through configuration or indication may override previous values for a similar parameter. Despite frequent references to IAB, the proposed solutions may be applicable to wireless relay nodes and other types of wireless communication entities.

L1/L2 control signaling may refer to control signaling in layer 1 (physical layer) or layer 2 (data link layer). Particularly, an L1/L2 control signaling may refer to an L1 control signaling such as a DCI message or a UCI message, an L2 control signaling such as a MAC message, or a combination thereof. A format and an interpretation of an L1/L2 control signaling may be determined by the standard, a configuration, other control signaling, or a combination thereof.

Reference is frequently made, in the present disclosure, to a message or an information element (IE). ‘IE’ is an acronym used frequently in LTE and NR specifications for referring to a configuration at layer 3 and higher. An IE may be included in a message from one layer to another layer or from one entity to another entity. Alternatively, an IE may be included within another IE. In the present disclosure, the terms ‘IE’ and ‘message’ may be used interchangeably when the message comprises the IE directly or indirectly. Any parameter discussed in this disclosure may appear, in practice, as a linear function of that parameter in signaling or specifications.

There is an emphasis in the description of the methods proposed in this disclosure to perform measurements for beam training on reference signals. Alternatively, in some embodiments, a measurement may be performed on resources that are not necessarily configured for reference signals, but rather a node may measure a receive signal power and obtain a receive signal strength indicator (RSSI) or the like.

In the present disclosure, reference is frequently made to beam indication. In practice, according to a standard specification, a beam indication may refer to an indication of a reference signal by an ID or indicator, a resource associated with a reference signal, and/or a spatial relation information comprising information of a reference signal or a reciprocal of a reference signal (in the case of beam correspondence).

The terms and acronyms introduced in the present disclosure may be different from those used in future standard specifications. For example, a beam pattern or a beam pattern entry as described in the present disclosure may be called by alternative terms. The term “entry” may be alternatively called a field, a parameter, or an IE. In some realizations, a beam pattern or a beam pattern entry may or may not comprise beam information.

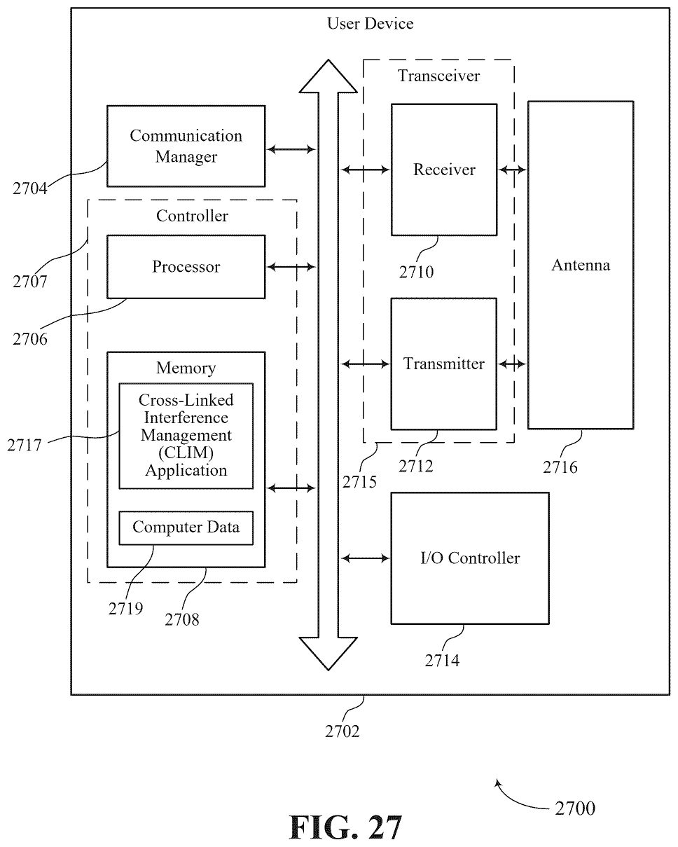

FIG. 27 illustrates an example of a block diagram 2700 of a UE 2702 that wirelessly communicates with the base stations that schedules dynamically changing flexible symbols in response to changes in communication traffic, in accordance with aspects of the present disclosure. The UE 2702 may be an example of a UE 104 as described herein. The UE 2702 may support wireless communication with one or more base stations or network nodes 102, UEs 104, or any combination thereof. The UE 2702 may include components for bi-directional communications including components for transmitting and receiving communications, such as a communication manager 2704, a processor 2706, a memory 2708, a receiver 2710, a transmitter 2712, and an I/O controller 2714. These components may be in electronic communication or otherwise coupled (e.g., operatively, communicatively, functionally, electronically, electrically) via one or more interfaces (e.g., buses). The receiver 2710 and transmitter 2712 may exist on a same chip and be collectively referred to as a transceiver 2715.

The communication manager 2704, the receiver 2710, the transmitter 2712, or various combinations thereof or various components thereof may be examples of means for performing various aspects of the present disclosure as described herein. For example, the communication manager 2704, the processor 2706, the receiver 2710, the transmitter 2712, or various combinations or components thereof may support a method for performing one or more of the functions described herein. In an example, the processor 2706 executes a cross-link interference management (CLIM) application 2717 that configures the communication manager 2704 to collect and report information relevant to CLIM. The CLIM application 2717 obtains and maintains computer data 2719 for tracking beam pattern data in support of a base station that performs CLIM.

In some implementations, the communication manager 2704, the receiver 2710, the transmitter 2712, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 2706 and the memory 2708 coupled with the processor 2706 may be components of a controller 2707 configured to perform one or more of the functions described herein (e.g., by executing, by the processor 2706, instructions stored in the memory 2708).

Additionally, or alternatively, in some implementations, the communication manager 2704, the receiver 2710, the transmitter 2712, or various combinations or components thereof may be implemented in code (e.g., as communications management software or firmware) executed by the processor 2706. If implemented in code executed by the processor 2706, the functions of the communication manager 2704, the receiver 2710, the transmitter 2712, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some implementations, the communication manager 2704 may be configured to perform various operations (e.g., receiving, monitoring, transmitting) using or otherwise in cooperation with the receiver 2710, the transmitter 2712, or both. For example, the communication manager 2704 may receive information from the receiver 2710, send information to the transmitter 2712, or be integrated in combination with the receiver 2710, the transmitter 2712, or both to receive information, transmit information, or perform various other operations as described herein. Although the communication manager 2704 is illustrated as a separate component, in some implementations, one or more functions described with reference to the communication manager 2704 may be supported by or performed by the processor 2706, the memory 2708, or any combination thereof. For example, the memory 2708 may store code, which may include instructions executable by the processor 2706 to cause the UE 2702 to perform various aspects of the present disclosure as described herein, or the processor 2706 and the memory 2708 may be otherwise configured to perform or support such operations.

The processor 2706 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 2706 may be configured to operate a memory array using a memory controller. In some other implementations, a memory controller may be integrated into the processor 2706. The processor 2706 may be configured to execute computer-readable instructions stored in a memory (e.g., the memory 2708) to cause/configure the UE 2702 to perform various functions of the present disclosure.

The memory 2708 may include random access memory (RAM) and read-only memory (ROM). The memory 2708 may store computer-readable, computer-executable code including instructions that, when executed by the processor 2706 cause the UE 2702 to perform various functions described herein. The code may be stored in a non-transitory computer-readable medium such as system memory or another type of memory. In some implementations, the code may not be directly executable by the processor 2706 but may cause/configure a computer (e.g., when the code is compiled and executed) to perform functions described herein. In some implementations, the memory 2708 may include, among other things, a basic I/O system (BIOS) which may control basic hardware or software operation such as the interaction with peripheral components or devices.

The I/O controller 2714 may manage input and output signals for the UE 2702. The I/O controller 2714 may also manage peripherals not integrated into the UE 2702. In some implementations, the I/O controller 2714 may represent a physical connection or port to an external peripheral. In some implementations, the I/O controller 2714 may utilize an operating system such as iOS®, ANDROID®, MS-DOS®, MS-WINDOWS®, OS/2®, UNIX®, LINUX®, or another known operating system. In some implementations, the I/O controller 2714 may be implemented as part of a processor, such as the processor 2706. In some implementations, a user may interact with the UE 2702 via the I/O controller 2714 or via hardware components controlled by the I/O controller 2714.

In some implementations, the UE 2702 may include a single antenna 2716. However, in some other implementations, the UE 2702 may have more than one antenna 2716, which may be capable of concurrently transmitting or receiving multiple wireless transmissions. The receiver 2710 and the transmitter 2712 may communicate bi-directionally, via the one or more antennas 2716, wired, or wireless links as described herein. For example, the receiver 2710 and the transmitter 2712 may represent a wireless transceiver and may communicate bi-directionally with another wireless transceiver. The transceiver may also include a modem to modulate the packets, to provide the modulated packets to one or more antennas 2716 for transmission, and to demodulate packets received from the one or more antennas 2716.

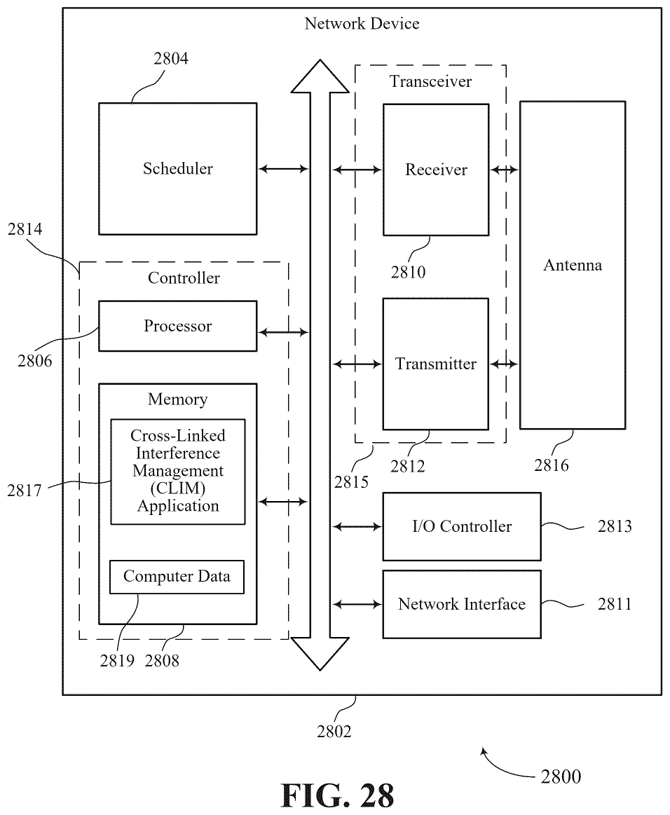

FIG. 28 illustrates an example of a block diagram 2800 of a network device 2802 that wirelessly communicates with user devices, and which also communicates with other base stations for cross-link interference management as an aggressor and/or a victim base station, in accordance with aspects of the present disclosure. The network device 2802 may be an example of a base station, a base node, or network node 102 as described herein. The network device 2802 may support wireless communication with one or more network nodes 102 and core network 106 as described in FIG. 1, UEs 104, or any combination thereof. The network device 2802 may include components for bi-directional communications including components for transmitting and receiving communications, such as a scheduler 2804, a processor 2806, a memory 2808, a receiver 2810, a network interface 2811, a transmitter 2812, and an I/O controller 2813. These components may be in electronic communication or otherwise coupled (e.g., operatively, communicatively, functionally, electronically, electrically) via one or more interfaces (e.g., buses). The receiver 2810 and transmitter 2812 may be located on a single chip and collectively referred to as a transceiver 2815. The network interface 2811 may support one or more wired network connections and communication protocols to communicate via backhaul links 114 and 116 (FIG. 1).

The scheduler 2804, the receiver 2810, the transmitter 2812, or various combinations thereof or various components thereof may be examples of means for performing various aspects of the present disclosure as described herein. For example, the scheduler 2804, the receiver 2810, the transmitter 2812, or various combinations or components thereof may support a method for performing one or more of the functions described herein.

In some implementations, the scheduler 2804, the receiver 2810, the transmitter 2812, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 2806 and the memory 2808 coupled with the processor 2806 may be components of a controller 2814 configured to perform one or more of the functions described herein (e.g., by executing, by the processor 2806, instructions stored in the memory 2808).

Additionally, or alternatively, in some implementations, the scheduler 2804, the receiver 2810, the transmitter 2812, or various combinations or components thereof may be implemented in code (e.g., as communications management software or firmware) executed by the processor 2806. If implemented in code executed by the processor 2806, the functions of the scheduler 2804, the receiver 2810, the transmitter 2812, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some implementations, the scheduler 2804 may be configured to perform various operations (e.g., receiving, monitoring, transmitting) using or otherwise in cooperation with the receiver 2810, the transmitter 2812, or both. For example, the scheduler 2804 may receive information from the receiver 2810, send information to the transmitter 2812, or be integrated in combination with the receiver 2810, the transmitter 2812, or both to receive information, transmit information, or perform various other operations as described herein. Although the scheduler 2804 is illustrated as a separate component, in some implementations, one or more functions described with reference to the scheduler 2804 may be supported by or performed by the processor 2806, the memory 2808, or any combination thereof. For example, the memory 2808 may store code, which may include instructions executable by the processor 2806 to cause/configure the network device 2802 to perform various aspects of the present disclosure as described herein, or the processor 2806 and the memory 2808 may be otherwise configured to perform or support such operations.

The processor 2806 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 2806 may be configured to operate a memory array using a memory controller. In some other implementations, a memory controller may be integrated into the processor 2806. The processor 2806 may be configured to execute computer-readable instructions stored in a memory (e.g., the memory 2808) to cause the network device 2802 to perform various functions of the present disclosure. In an example, the processor 2806 executes CLIM application 2817 that configures the scheduler 2804 to perform CLIM. CLIM application 2817 obtains and maintains computer data 2819 for tracking beam pattern data in support of a base station that performs CLIM as either a source/aggressor and/or as a target/victim.

The memory 2808 may include random access memory (RAM) and read-only memory (ROM). The memory 2808 may store computer-readable, computer-executable code including instructions that, when executed by the processor 2806 cause the network device 2802 to perform various functions described herein. The code may be stored in a non-transitory computer-readable medium such as system memory or another type of memory. In some implementations, the code may not be directly executable by the processor 2806 but may cause/configure a computer (e.g., when compiled and executed) to perform functions described herein. In some implementations, the memory 2808 may include, among other things, a basic I/O system (BIOS) which may control basic hardware or software operation such as the interaction with peripheral components or devices.

The I/O controller 2813 may manage input and output signals for the network device 2802. The I/O controller 2813 may also manage peripherals not integrated into the network device 2802. In some implementations, the I/O controller 2813 may represent a physical connection or port to an external peripheral. In some implementations, the I/O controller 2813 may utilize an operating system such as iOS®, ANDROID®, MS-DOS®, MS-WINDOWS®, OS/2®, UNIX®, LINUX®, or another known operating system. In some implementations, the I/O controller 2813 may be implemented as part of a processor, such as the processor 2806. In some implementations, a user may interact with the network device 2802 via the I/O controller 2813 or via hardware components controlled by the I/O controller 2813.

In some implementations, the network device 2802 may include a single antenna 2816. However, in some other implementations, the network device 2802 may have more than one antenna 2816, which may be capable of concurrently transmitting or receiving multiple wireless transmissions. The receiver 2810 and the transmitter 2812 may communicate bi-directionally, via the one or more antennas 2816, wired, or wireless links as described herein. For example, the receiver 2810 and the transmitter 2812 may represent a wireless transceiver and may communicate bi-directionally with another wireless transceiver. The transceiver may also include a modem to modulate the packets, to provide the modulated packets to one or more antennas 2816 for transmission, and to demodulate packets received from the one or more antennas 2816.

According to aspects of the present disclosure, a network device 2802 is provided for wireless communication as a network node. In one or more embodiments, the network node includes the network interface 2811, the transceiver 2815 that includes at least one receiver 2810 and at least one transmitter 2812 that enable the network node to communicate with one or more UEs 104 (FIG. 1). The controller 2814 of the network node (network device 2802) is communicatively coupled to the network interface 2811 and the transceiver 2815. The controller 2814 determines downlink transmission parameters to communicate downlink resources to the one or more UEs 104 (FIG. 1). The controller 2814 identifies a spatial pattern to communicate the downlink resources to the one or more UEs 104 (FIG. 1). The controller 2814 communicates, via the network interface 2811 to a second network node, a spatial pattern information element (IE) containing at least one indication of the spatial pattern for cross-link interference management. The spatial pattern IE enables the second network node to mitigate interference.

In one or more embodiments, the controller 2814 determines the downlink transmission parameters to communicate the downlink resources by allocating resources in at least one of a time domain and a frequency domain for wireless communication. In one or more embodiments, the controller 2814 identifies the spatial pattern of one or more spatial pattern entries. In one or more particular embodiments, the controller 2814 identifies the spatial pattern by identifying, for each of one or more spatial pattern entries, at least one indication of: (i) a reference signal; (ii) at least one beam index of a plurality of beam indices; (iii) associated resources; and (iv) a transmission power parameter.

In one or more embodiments, the controller 2814 schedules the downlink communication to the one or more UEs 104 (FIG. 1) on a physical downlink shared channel (PDSCH) based on the determining downlink transmission parameters to communicate the downlink resources to the one or more user devices. In one or more embodiments, the controller 2814 receives from the second network node a spatial pattern response comprising a high-interference beam indication. The controller 2814 identifies at least one spatial pattern entry indicated by the spatial pattern response to cause an excessive interference on a communication of the second network node. The controller 2814 initiates an interference mitigation action in association with the at least one spatial pattern entry.

In one or more embodiments, in communicating the spatial pattern IE to the second network node, the controller 2814 communicates the spatial pattern IE to a network entity of a core network 106 (FIG. 1) that communicates the spatial pattern IE to the second network node. In one or more particular embodiments, the network entity is an access and mobility function (AMF).

In one or more aspects of the present disclosure, a network device 2802 such as a network node is provided for wireless communication. In one or more embodiments, the network node includes a network interface 2811 and a transceiver 2815 including at least one receiver 2810 and at least one transmitter 2812 that enable the network node to communicate with one or more UEs 104 (FIG. 1). A controller 2814 of the network node is communicatively coupled to network interface 2811 and the transceiver 2815. The controller 2814 receives, via the network interface 2811 from an originating network interface 2811, a spatial pattern information element (IE) containing at least one indication of a spatial pattern transmitted by the originating network node. The controller 2814 obtains an interference estimate based on measurements on a resource set associated with a reference signal identified by the spatial pattern IE for the at least one indication of a spatial pattern. The controller 2814 compares the interference estimate with an interference threshold. In response to determining that the interference estimate is larger than the interference threshold, the controller 2814 communicates a high-interference beam indication to the originating network node to prompt cross-link interference management by the originating network node.

In one or more embodiments, the received reference signal comprises at least one of a synchronization signal block (SSB), a channel state information reference signal (CSI-RS), or a sounding reference signal (SRS). In one or more embodiments, the high-interference beam indication comprises at least one of: (i) an index associated with a spatial pattern entry of one or more spatial pattern entries of the spatial pattern; (ii) an index associated with the reference signal; (iii) an index associated with the one or more spatial pattern entries; and (iv) an amount of excess interference computed based on the interference estimate and the interference threshold. In one or more particular embodiments, the one or more beams indices comprise reference signal resource indices. In one or more embodiments, the spatial pattern IE includes one or more spatial pattern entries. Each entry includes at least one indication of: (i) a reference signal; (ii) at least one beam index of a plurality of beam indices; (iii) associated resources; and (iv) a transmission power parameter that is a transmission power offset with respect to the reference signal.

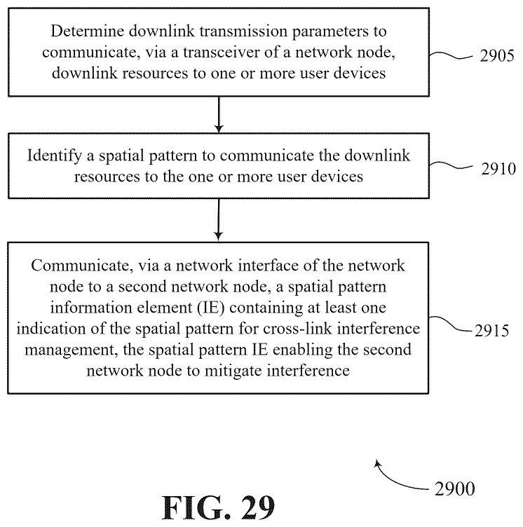

FIG. 29 illustrates a flowchart of a method 2900 for cross-link interference management by an originating base station that may otherwise act as an “aggressor” toward a second base station, referred to as a “victim”, in accordance with aspects of the present disclosure. Method 2900 may particularly address transmission of dynamic TDD communication of flexible symbols that may be simultaneously received on an uplink by the second base station. The operations of method 2900 may be implemented by a device or its components as described herein. For example, the operations of method 2900 may be performed by a network device, base node, base station, or network node 102 as described with reference to FIGS. 1 through 26 and 28. In some implementations, the network device may execute a set of instructions to control the function elements of the network device to perform the described functions. Additionally, or alternatively, the network device may perform aspects of the described functions using special-purpose hardware.

At 2905, the method 2900 may include determining downlink transmission parameters to communicate, via a transceiver of a network node, downlink resources to one or more user devices. The operations of 2905 may be performed in accordance with examples as described herein. In some implementations, aspects of the operations of 2905 may be performed by a device as described with reference to FIG. 1 or 28.

At 2910, the method 2900 may include identifying a spatial pattern to communicate the downlink resources to the one or more user devices. The operations of 2910 may be performed in accordance with examples as described herein. In some implementations, aspects of the operations of 2910 may be performed by a device as described with reference to FIG. 1 or 28.

At 2915, the method 2900 may include communicating, via a network interface of the network node to a second network node, a spatial pattern information element (IE) containing at least one indication of the spatial pattern for cross-link interference management, the spatial pattern IE enabling the second network node to mitigate interference. The operations of 2915 may be performed in accordance with examples as described herein. In some implementations, aspects of the operations of 2915 may be performed by a device as described with reference to FIG. 1 or 28.

In one or more embodiments, determining the downlink transmission parameters to communicate the downlink resources includes allocating resources in at least one of a time domain and a frequency domain for wireless communication. In one or more embodiments, the method 2900 includes identifying the spatial pattern of one or more spatial pattern entries. In one or more particular embodiments, the method 2900 includes identifying the spatial pattern by identifying, for each of the one or more spatial pattern entries, the at least one indication of: (i) a reference signal; (ii) at least one beam index of a plurality of beam indices; (iii) associated resources; and (iv) a transmission power parameter.

In one or more embodiments, the method 2900 includes scheduling the downlink communication to the one or more user devices on a physical downlink shared channel (PDSCH) based on the determining downlink transmission parameters to communicate the downlink resources to the one or more user devices. In one or more embodiments, the method 2900 includes receiving from the second network node a spatial pattern response comprising a high-interference beam indication. The method 2900 includes identifying at least one spatial pattern entry indicated by the spatial pattern response to cause an excessive interference on a communication of the second network node. The method 2900 includes initiating an interference mitigation action in association with the at least one spatial pattern entry.

In one or more embodiments, the method 2900 includes communicating the spatial pattern IE to the second network node comprises communicating the spatial pattern IE to a network entity of a core network that communicates the spatial pattern IE to the second network node. In one or more particular embodiments, the network entity is an access and mobility function (AMF).

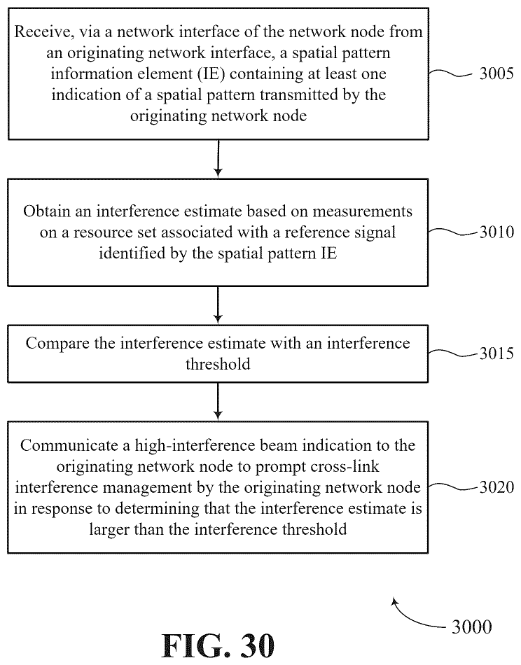

FIG. 30 illustrates a flowchart of a method 3000 for cross-link interference management by a terminating base station that is a victim of an originating base station that acts as an aggressor, in accordance with aspects of the present disclosure. Method 3000 may particularly address transmission of dynamic TDD communication of flexible symbols that may be received on an uplink by the base station. The operations of the method 3000 may be implemented by a device or its components as described herein. For example, the operations of the method 3000 may be performed by a network device, base node, base station, or network node 102 as described with reference to FIGS. 1 through 26 and 28. In some implementations, the network device may execute a set of instructions to control the function elements of the network device to perform the described functions. Additionally, or alternatively, the network device may perform aspects of the described functions using special-purpose hardware.

At 3005, the method 3000 may include receiving, via a network interface of the network node from an originating network interface, a spatial pattern information element (IE) containing at least one indication of a spatial pattern transmitted by the originating network node. The operations of 3005 may be performed in accordance with examples as described herein. In some implementations, aspects of the operations of 3005 may be performed by a device as described with reference to FIG. 1 or 28.

At 3010, the method 3000 may include obtaining an interference estimate based on measurements on a resource set associated with a reference signal identified by the spatial pattern IE. The operations of 3010 may be performed in accordance with examples as described herein. In some implementations, aspects of the operations of 3010 may be performed by a device as described with reference to FIG. 1 or 28.

At 3015, the method 3000 may include comparing the interference estimate with an interference threshold. The operations of 3015 may be performed in accordance with examples as described herein. In some implementations, aspects of the operations of 3015 may be performed by a device as described with reference to FIG. 1 or 28.

At 3020, the method 3000 may include communicating a high-interference beam indication to the originating network node to prompt to prompt a cross-link interference mitigation action by the originating network node in response to determining that the interference estimate is larger than the interference threshold. The operations of 3020 may be performed in accordance with examples as described herein. In some implementations, aspects of the operations of 3020 may be performed by a device as described with reference to FIG. 1 or 28.

In one or more embodiments, the received reference signal comprises at least one of a synchronization signal block (SSB), a channel state information reference signal (CSI-RS), or a sounding reference signal (SRS). In one or more embodiments, the high-interference beam indication comprises at least one of: (i) an index associated with a spatial pattern entry of one or more spatial pattern entries of the spatial pattern; (ii) an index associated with the reference signal; (iii) an index associated with the one or more spatial pattern entries; and (iv) an amount of excess interference computed based on the interference estimate and the interference threshold. In one or more embodiments, the spatial pattern IE includes one or more spatial pattern entries, each including at least one indication of: (i) a reference signal; (ii) at least one beam index of a plurality of beam indices; (iii) associated resources; and (iv) a transmission power parameter that is a transmission power offset with respect to the reference signal.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The terms “transmitting,” “receiving,” or “communicating,” when referring to a network node, may refer to any portion of a network entity (e.g., a base station, a CU, a DU, a RU) of a RAN communicating with another device (e.g., directly or via one or more other network entities).

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A base station for wireless communication, the base station comprising:
a memory; and
a processor communicatively coupled to the memory, and which is configured to cause the base station to:
determine downlink transmission parameters to communicate downlink resources to the one or more user equipment (UEs);
identify a spatial pattern to communicate the downlink resources to the one or more UEs; and
communicate, to a second base station, a spatial pattern information element (IE) containing at least one indication of the spatial pattern for cross-link interference management, the spatial pattern IE enabling the second base station to mitigate interference.

2. The base station of claim 1, wherein the processor causes the base station to determine the downlink transmission parameters to communicate the downlink resources by allocating resources in at least one of a time domain and a frequency domain for wireless communication.

3. The base station of claim 1, wherein the processor causes the base station to identify identifies the spatial pattern by identifying, for each of one or more spatial pattern entries, at least one indication of: (i) a reference signal; (ii) at least one beam index of a plurality of beam indices; (iii) associated resources; and (iv) a transmission power parameter.

4. The base station of claim 1, wherein the processor causes the base station to schedule downlink communication to the one or more UEs on a physical downlink shared channel (PDSCH) based on the determining downlink transmission parameters to communicate the downlink resources to the one or more user devices.

5. The base station of claim 1, wherein the processor causes the base station to:
receive from the second base station a spatial pattern response comprising a high-interference beam indication;
identify at least one spatial pattern entry indicated by the spatial pattern response to cause an excessive interference on a communication of the second base station; and
initiate an interference mitigation action in association with the at least one spatial pattern entry.

6. The base station of claim 1, wherein, in communicating the spatial pattern IE to the second base station, the processor causes the base station to communicate the spatial pattern IE to a network entity of a core network that communicates the spatial pattern IE to the second base station.

7. The base station of claim 6, wherein the network entity comprises an access and mobility function (AMF).

8. A controller for wireless communication by a base station, the controller comprising:
a memory; and
a processor communicatively coupled to the memory and which is configured to cause the controller to:
determine downlink transmission parameters to communicate downlink resources to one or more user equipment (UEs);
identify a spatial pattern to communicate the downlink resources to the one or more UEs; and
communicate, via a network interface to a second base station, a spatial pattern information element (IE) containing at least one indication of the spatial pattern for cross-link interference management, the spatial pattern IE enabling the second base station to mitigate interference.

9. The controller of claim 8, wherein the processor further causes the controller to determine the downlink transmission parameters to communicate the downlink resources by allocating resources in at least one of a time domain and a frequency domain for wireless communication.

10. The controller of claim 8, wherein the processor further causes the controller to identify the spatial pattern by identifying, for each of one or more spatial pattern entries, at least one indication of: (i) a reference signal; (ii) at least one beam index of a plurality of beam indices; (iii) associated resources; and (iv) a transmission power parameter.

11. The controller of claim 8, wherein the code processor further causes the controller to schedule downlink communication to the one or more UEs on a physical downlink shared channel (PDSCH) based on the determining downlink transmission parameters to communicate the downlink resources to the one or more user devices.

12. The controller of claim 8, wherein the processor further causes the controller to:
receive from the second base station a spatial pattern response comprising a high-interference beam indication;
identify at least one spatial pattern entry indicated by the spatial pattern response to cause an excessive interference on a communication of the second base station; and
initiate an interference mitigation action in association with the at least one spatial pattern entry.

13. The controller of claim 8, wherein, to communicate the spatial pattern IE to the second base station, the processor causes the controller to communicate the spatial pattern IE to a network entity of a core network that communicates the spatial pattern IE to the second base station.

14. A method of wireless communication by a base station, the method comprising:
determining downlink transmission parameters to communicate, via a transceiver of the base station, downlink resources to one or more user equipment (UEs);
identifying a spatial pattern to communicate the downlink resources to the one or more UEs; and
communicating, via a network interface of the base station to a second base station, a spatial pattern information element (IE) containing at least one indication of the spatial pattern for cross-link interference management, the spatial pattern IE enabling the second base station to mitigate interference.

15. The method of claim 14, wherein determining the downlink transmission parameters to communicate the downlink resources comprises allocating resources in at least one of a time domain and a frequency domain for wireless communication.

16. The method of claim 14, further comprising identifying the spatial pattern of one or more spatial pattern entries by identifying, for each of the one or more spatial pattern entries, the at least one indication of: (i) a reference signal; (ii) at least one beam index of a plurality of beam indices; (iii) associated resources; and (iv) a transmission power parameter.

17. The method of claim 14, further comprising:
receiving from the second base station a spatial pattern response comprising a high-interference beam indication;
identifying at least one spatial pattern entry indicated by the spatial pattern response to cause an excessive interference on a communication of the second base station; and
initiating an interference mitigation action in association with the at least one spatial pattern entry.

18. The method of claim 14, wherein communicating the spatial pattern IE to the second base station comprises communicating the spatial pattern IE to a network entity of a core network that communicates the spatial pattern IE to the second base station.

19. A base station for wireless communication, the base station comprising:
a memory; and
a processor communicatively coupled to the memory, and which is configured to cause the base station to:
receive, from an originating base station, a spatial pattern information element (IE) containing at least one indication of a spatial pattern transmitted by the originating base station;
obtain an interference estimate based on measurements on a resource set associated with a reference signal identified by the spatial pattern IE for the at least one indication of a spatial pattern;
compare the interference estimate with an interference threshold; and
in response to determining that the interference estimate is larger than the interference threshold, communicate a high-interference beam indication to the originating base station to prompt cross-link interference management by the originating base station.

20. The base station of claim 19, wherein:
the reference signal comprises at least one of a synchronization signal block (SSB), a channel state information reference signal (CSI-RS), or a sounding reference signal (SRS); and
the high-interference beam indication comprises at least one of: (i) an index associated with a spatial pattern entry of one or more spatial pattern entries of the spatial pattern; (ii) an index associated with the reference signal; (iii) an index associated with the one or more spatial pattern entries; and (iv) an amount of excess interference computed based on the interference estimate and the interference threshold.
